(19) United States
(12) Patent Application Publication
(10) Pub. No.: US 2026/0228891 A1
(43) Pub. Date: Aug. 6, 2026

(54) DIGITAL IMAGING AND ARTIFICIAL INTELLIGENCE (AI)-BASED SYSTEMS AND METHODS FOR ANALYZING ORAL CARE IMPLEMENT DEGRADATION

(71) Applicant: The Procter & Gamble Company, Cincinnati, OH (US)

(72) Inventors: Sol Melissa ESCOBAR, Mason, OH (US); Faiz Feisal SHERMAN, Mason, OH (US); Meraj KHAN, Cincinnati, OH (US); Neha PANDEY, Hessen (DE); Katherine DRAB, Dublin, OH (US)

(21) Appl. No.: 19/461,941

(22) Filed: Jan. 28, 2026

Related U.S. Application Data
(60) Provisional application No. 63/752,087, filed on Jan. 31, 2025.

(51) Int. Cl. G06T 7/00

(52) U.S. Cl. CPC G06T 7/0012; G06T 2207/20081; G06T 2207/30036

(57) ABSTRACT

Digital imaging and artificial intelligence (AI)-based systems and methods for analyzing oral care implement degradation. Image(s) comprising pixel data of an oral care implement of a user are obtained and a type corresponding to a specific expected oral care implement lifecycle is detected. The image(s) and type are input into an oral care implement artificial intelligence (AI) model that outputs a user-specific degradation value of the oral care implement based on the type of the oral care implement and the pixel data depicting the physical features of the oral care implement. A user-specific degradation analysis is generated based on the AI output that includes a comparison between the oral care implement of the user at an estimated time state and a target oral care implement at a target time state. A feedback indication is output based on the user-specific degradation analysis of the oral care implement.

### CROSS REFERENCE TO RELATED APPLICATION

This application claims the benefit of U.S. Provisional Application No. 63/752,087, filed Jan. 31, 2025, the substance of which is incorporated herein by reference.

### FIELD

The present disclosure generally relates to digital imaging and artificial intelligence (AI)-based systems and methods. More particularly, the present disclosure relates to digital imaging and AI-based systems and methods for analyzing oral care implement degradation.

### BACKGROUND

Proper oral hygiene practices are a critical component of public health worldwide, playing a key role in preventing oral diseases such as cavities and gum disease. Through initiatives including educational campaigns, community dental screenings, and formal governmental and regulatory efforts, organizations such as the World Health Organization (WHO), the United States Centers for Disease Control and Prevention (CDC), and others strive to address disparities in access to dental care and promote proper at-home oral hygiene practices.

Despite these efforts, consumer research and numerous dental case studies indicate that educational initiatives and improved access have achieved only moderate success in enhancing oral health behaviors. This is exemplified by the persistence of cavities, caused by dental caries, which remain one of the most prevalent diseases worldwide. The widespread availability of fluoridated toothpaste and decades of public health education have not yet yielded the desired outcomes in oral and public health.

This gap between education and action extends beyond disease prevalence to general at-home care practices. Research highlights gaps in consumer compliance with guidelines, such as correct toothpaste dosing or timely toothbrush replacement. These behaviors often deviate from recommended practices, suggesting an opportunity to move beyond broad educational campaigns and instead offer tailored tools and solutions that enable individuals to adopt better habits, specific to their products and needs.

For example, in the case of oral care tools like toothbrushes, dental experts generally recommend replacing them every three to four months, or sooner if the bristles become splayed. Additionally, toothbrushes should be replaced in specific situations, such as after recovering from a cold or flu. Organizations such as the American Dental Association (ADA) also advise adapting replacement schedules based on individual brushing habits and storage conditions. However, these recommendations face two primary challenges: first, the general public may lack awareness of these guidelines due to limited education or access to dental care; second, consumers often fail to consistently monitor the condition of their toothbrushes, as demonstrated by various behavioral studies.

Moreover, research into toothbrushes has revealed that the rate and degree of bristle degradation can vary significantly depending on the specific design and materials of the toothbrush. Factors such as bristle hardness, bristle orientation, and the structural composition of the toothbrush head have been shown to influence wear and tear. With a wide array of toothbrush models and designs available on the market, each with unique properties, it can be challenging for consumers to accurately determine the appropriate time for replacement. This challenge is further compounded by the previously mentioned barriers to education and consistent habit formation.

Still further, consumer-acquired images are inherently uncontrolled and vary widely in key parameters such as camera distance, orientation, and illumination. These variations result in inconsistent image quality, specifically in terms of object size and color fidelity. Traditional image analysis methods, which rely on consistent inputs and predefined parameters, struggle to produce reliable measurements under such variable conditions. As a result, the outputs from conventional techniques often lack the precision and accuracy needed for meaningful analysis.

In addition, the patterns across different brushes or other personal care devices are inconsistent and highly variable, influenced by factors such as usage habits, brush material, and environmental conditions. This variability makes it exceedingly difficult to define universal heuristics or rule-based systems that can map image-derived measurements to wear levels. Conventional approaches, which depend on fixed algorithms or deterministic rules, are inadequate to handle the complexity and diversity inherent in these wear patterns.

For the foregoing reasons, there is a need for digital imaging and artificial intelligence (AI)-based systems and methods for analyzing oral care implement degradation, which may include, for example, analyzing an oral care implement (e.g., a toothbrush) to provide feedback as to degradation of the oral care implement (e.g., the toothbrush) based on details or features identifiable within pixel data of one or more images captured of the oral care implement.

### SUMMARY

Generally, as described herein, digital imaging and artificial intelligence (AI)-based systems and methods are described for analyzing care implement (e.g., oral care implement, grooming care implement) degradation. Such digital imaging and AI-based systems provide a technical solution for overcoming problems that arise from the difficulties in identifying degradation for various care implements (e.g., oral care implements), where such degradation can reduce or eliminate efficacy for particular treatment applications with a given care implement. The digital imaging and artificial intelligence (AI)-based systems and methods can analyze parameters or features (e.g., pixel data features) related to a particular care implement and related user care, and other parameters or features to determine a proper time for replacement of the particular care implement, or otherwise assess the state of the care implement at any point in time.

The digital imaging and AI-based systems and methods as described herein allow a user to submit one or more images to imaging server(s) (e.g., including its one or more processors), or otherwise a computing device (e.g., such as locally on the user's mobile device), where the imaging server(s) or user computing device, implements or executes an AI-based learning model. e.g. In one example, an AI-based learning model may comprise a care implement AI model, grooming AI model, or otherwise AI model trained with pixel data of potentially 10,000s (or more) images depicting care implements (e.g., oral care implements and/or otherwise personal care implements as various states or otherwise stages of time or use). In another example, an AI-based learning model may comprise a care implement AI model, grooming AI model, or otherwise AI model trained with fewer images (e.g., on the order of 100s) depicting care implements (e.g., oral care implements and/or otherwise personal care implements as various states or otherwise stages of time or use). Still further, an additional an AI-based learning model may comprise a pretrained model (e.g., a generative AI model) previously trained on images and that can be finetuned with specific images in the oral, grooming, or otherwise care field depicting care implements (e.g., oral care implements and/or otherwise personal care implements as various states or otherwise stages of time or use). Still further, an additional an AI-based learning model may comprise a multimodal model (e.g., a multimodal generative AI model) that can be further trained on images via zero to 10s of images in the oral, grooming, or otherwise care field depicting care implements (e.g., oral care implements and/or otherwise personal care implements as various states or otherwise stages of time or use). In various cases, use of additional images can be used to improve the various types of AI models (e.g., supervised learning based models and/or generative AI models models). The base optimal size of a given training dataset for such model can correlate with the algorithm used to train the model and/or whether there is an existing model, e.g., a generative model, to finetune or otherwise update. This could include, for example, use of 1000s of images to train a traditional convolutional neural network (CNN) model compared to fewer images required to train an existing generative AI model, such as a Multimodal LLM).

Additionally, or alternatively, the AI-based learning model (e.g., a care implement AI model, grooming AI model) may comprise a generative AI model, such as a large language model (LLM), multimodal LLM, or other generative AI model, trained with millions or billions of parameters and configured to receive images and output generative output based on such images. The artificial intelligence model (e.g., a care implement AI model) may generate, based on pixel data of a given image, a feedback indication designed to address at least one feature identifiable within the pixel data depicting the physical features of the oral care implement including wear level of the care implement (e.g., splayed or frayed bristles of a toothbrush). For example, an image of a care implement can comprise pixels or pixel data indicative of an oral care implement (e.g., a toothbrush). In some embodiments, the feedback indication may be transmitted via a computer network to a user computing device of the user for rendering on a display screen. In other embodiments, no transmission to the imaging server of the user's specific image occurs, where the feedback indication may instead be generated by the artificial intelligence model (e.g., a care implement AI model), executing and/or implemented locally on the user's mobile device and rendered, by a processor of the mobile device, on a display screen of the mobile device. In various embodiments, such rendering may include graphical representations, overlays, annotations, and the like for addressing the feature in the pixel data.

By training a care implement AI model (e.g., an oral care implement AI model) on a diverse dataset of images and wear patterns for various time states, the care implement AI model can effectively normalize inconsistencies in image quality and adapt to variations in wear patterns. This capability enables the invention to deliver accurate, scalable, and robust analysis across a wide range of conditions and product types (e.g., brush types or razor types), thereby overcoming the limitations of non-AI methods.

Further, the digital imaging and AI-based systems and methods described herein reduce erroneous or non-efficient use of a given care implement by detecting worn or non-effective care implements and can provide immediate consumer feedback about when to replace and/or upgrade a given care implement. In various aspects, a time state is used to analyze or compare given products of the same make or model. In such aspects, a reference image of a new or otherwise unused care implement can be compared to a used care implement (e.g., a used oral care implement such as a splayed toothbrush) to determine a wear level. The digital imaging and AI-based systems and methods disclosed herein train a care implement AI model (e.g., an oral care implement AI model) to detect such changes, such as degradation over time. The care implement AI model can be updated with new images so as to adapt the detection and feedback according to various time states.

In some aspects, the techniques described herein relate to a digital imaging and artificial intelligence (AI)-based system configured to analyze oral care implement degradation, the digital imaging and AI-based system including: one or more processors; an oral analysis app including computing instructions configured to execute on the one or more processors; and an oral care implement artificial intelligence (AI) model, accessible by the oral analysis app, and trained with degradation data of one or more oral care implements, the oral care implement AI model further trained with pixel data of a plurality of training images depicting the one or more oral care implements including one or more types and having varied physical degradations at different time states across one or more expected oral care implement lifecycles, and the oral care implement AI model trained to output respective degradation values corresponding to the one or more oral care implements and their respective varied physical degradations at the different time states across the one or more expected oral care implement lifecycles, wherein the computing instructions of the oral analysis app when executed by the one or more processors, cause the one or more processors to: obtain a set of one or more images of an oral care implement of a user, the set of one or more images including pixel data as captured by an imaging device, and the pixel data depicting physical features of the oral care implement, detect a type of the oral care implement, the type corresponding to a specific expected oral care implement lifecycle for the detected oral care implement, input into the oral care implement AI model the one or more images of the oral care implement, the input causing the oral care implement AI model to output a user-specific degradation value of the oral care implement based on the type of the oral care implement and the pixel data depicting the physical features of the oral care implement, generate, based on the output of the user-specific degradation value, a user-specific degradation analysis for the oral care implement, the degradation analysis including a comparison between the oral care implement of the user at an estimated time state and a target oral care implement at a target time state, output, based on the user-specific degradation analysis, a feedback indication designed to address at least one feature identifiable within the pixel data depicting the physical features of the oral care implement.

In some aspects, the techniques described herein relate to a digital imaging and artificial intelligence (AI)-based method for analyzing oral care implement degradation, the digital imaging and AI-based method including: obtaining, by an oral analysis app including computing instructions configured to execute on one or more processors a set of one or more images of an oral care implement of a user, the set of one or more images including pixel data as captured by an imaging device, and the pixel data depicting physical features of the oral care implement; detecting, by the one or more processors, a type of the oral care implement, the type corresponding to a specific expected oral care implement lifecycle for the detected oral care implement; inputting into an oral care implement artificial intelligence (AI) model the one or more images of the oral care implement, the input causing the oral care implement AI model to output a user-specific degradation value of the oral care implement based on the type of the oral care implement and the pixel data depicting the physical features of the oral care implement, wherein the oral care implement AI model is accessible by the oral analysis app, and is trained with degradation data of one or more oral care implements, the oral care implement AI model further trained with pixel data of a plurality of training images depicting the one or more oral care implements including one or more types and having varied physical degradations at different time states across one or more expected oral care implement lifecycles, and wherein the oral care implement AI model trained to output respective degradation values corresponding to the one or more oral care implements and their respective varied physical degradations at the different time states across the one or more expected oral care implement lifecycles; generating, by the one or more processors, based on the output of the user-specific degradation value, a user-specific degradation analysis for the oral care implement, the degradation analysis including a comparison between the oral care implement of the user at an estimated time state and a target oral care implement at a target time state; and outputting, by the one or more processors, based on the user-specific degradation analysis, a feedback indication designed to address at least one feature identifiable within the pixel data depicting the physical features of the oral care implement.

In some aspects, the techniques described herein relate to a tangible, non-transitory computer-readable medium storing instructions for analyzing oral care implement degradation, that when executed by one or more processors cause the one or more processors to: obtain, by an oral analysis app including computing instructions configured to execute on one or more processors a set of one or more images of an oral care implement of a user, the set of one or more images including pixel data as captured by an imaging device, and the pixel data depicting physical features of the oral care implement; detect, by the one or more processors, a type of the oral care implement, the type corresponding to a specific expected oral care implement lifecycle for the detected oral care implement; input into an oral care implement artificial intelligence (AI) model the one or more images of the oral care implement, the input causing the oral care implement AI model to output a user-specific degradation value of the oral care implement based on the type of the oral care implement and the pixel data depicting the physical features of the oral care implement; wherein the oral care implement AI model is accessible by the oral analysis app, and is trained with degradation data of one or more oral care implements, the oral care implement AI model further trained with pixel data of a plurality of training images depicting the one or more oral care implements including one or more types and having varied physical degradations at different time states across one or more expected oral care implement lifecycles, and wherein the oral care implement AI model trained to output respective degradation values corresponding to the one or more oral care implements and their respective varied physical degradations at the different time states across the one or more expected oral care implement lifecycles; generate, by the one or more processors, based on the output of the user-specific degradation value, a user-specific degradation analysis for the oral care implement, the degradation analysis including a comparison between the oral care implement of the user at an estimated time state and a target oral care implement at a target time state; and output, by the one or more processors, based on the user-specific degradation analysis, a feedback indication designed to address at least one feature identifiable within the pixel data depicting the physical features of the oral care implement.

In accordance with the above, and with the disclosure herein, the present disclosure includes improvements in computer functionality or in improvements to other technologies at least because the disclosure describes that, e.g., an imaging server, or otherwise computing device (e.g., a user computer device), is improved where the intelligence or predictive ability of the server or computing device is enhanced by a trained (e.g., machine learning trained) care implement AI model (e.g., an oral care implement AI model). The care implement AI model, executing on the imaging server or computing device, is able to more accurately identify, based on pixel data of various care implements, feedback indications designed to address at least one feature identifiable within the pixel data depicting the physical features of the oral care implement. The care implement AI model is trained to detect wear patterns that are not universal because different care implements (e.g., toothbrushes and/or razors) wear out differently. That is, the present disclosure describes improvements in the functioning of the computer itself or “any other technology or technical field” because an imaging server or user computing device is enhanced with a plurality of training images (e.g., 10,000s of training images and related pixel data as feature data) to accurately predict, detect, classify, or determine pixel data of a images, such as manufacturer provided images and/or newly provided user images. This improves over the prior art at least because existing systems lack such predictive or classification functionality and are simply not capable of accurately analyzing user-specific and/or manufacturer provided images to output a predictive result to address at least one feature identifiable within the pixel data depicting the physical features of the oral care implement.

In addition, the present disclosure relates to improvements to other technologies or technical fields at least because the present disclosure describes or introduces improvements to computing devices in the care implement field, whereby the trained care implement AI model (e.g., oral care implement AI model) executing on the imaging device(s) or computing device(s) improve the underlying computer device (e.g., imaging server(s) and/or user computing device), where such computer devices are made more efficient by the configuration, adjustment, adaptation, and/or otherwise update of a given machine-learning network architecture. For example, in some embodiments, fewer machine resources (e.g., processing cycles or memory storage) may be used by decreasing computational resources by decreasing machine-learning network architecture needed to analyze images, including by reducing depth, width, image size, or other machine-learning based dimensionality requirements. Such a reduction frees up the computational resources of an underlying computing system, thereby making it more efficient.

Still further, the present disclosure relates to improvement to other technologies or technical fields at least because the present disclosure describes or introduces improvements to computing devices in the field of security, where images of products are preprocessed (e.g., cropped or otherwise modified) to define extracted or depicted care implement portions (e.g., oral care implement portions, such as a portion of a toothbrush) without depicting personal identifiable information (PII) of a user. For example, cropped or redacted portions of an image of a care implement may be used by a care implement AI model described herein, which eliminates the need of transmission of images that may include users using such products across a computer network (where such images may be susceptible of interception by third parties). Such features provide a security improvement, i.e., where the removal of PII (e.g., facial features) provides an improvement over prior systems because cropped or redacted images, especially ones that may be transmitted over a network (e.g., the Internet), are more secure without including PII information of a user. Accordingly, the systems and methods described herein operate without the need for such non-essential information, which provides an improvement, e.g., a security improvement, over prior systems. In addition, the use of cropped images, at least in some embodiments, allows the underlying system to store and/or process smaller data size images, which results in a performance increase to the underlying system as a whole because the smaller data size images require less storage memory and/or processing resources to store, process, and/or otherwise manipulate by the underlying computer system.

In addition, the present disclosure includes specific features other than what is well-understood, routine, conventional activity in the field, or adding unconventional steps that confine the claim to a particular useful application, e.g., AI-based systems and methods for analyzing oral care implement degradation, which may include, for example, analyzing an oral care implement (e.g., a toothbrush) to provide feedback as to degradation of the oral care implement (e.g., the toothbrush) based on details or features identifiable within pixel data of one or more images captured of the oral care implement. Aspects of may also include digital imaging and AI-based systems and methods for analyzing oral care implement degradation, for example, analyzing an oral care implement usage in real-time or near real-time as detected within one or more images (e.g., a video) to provide feedback, which may include a same type of oral care implement and recommendations regarding the oral care implement in view of degradation based on the one or more images.

### BRIEF DESCRIPTION OF THE DRAWINGS

FIG. 1 illustrates an example digital imaging and artificial intelligence (AI)-based system configured to analyze oral care implement degradation.

FIG. 2A illustrates an example image and its related pixel data depicting an oral care implement depicting degradation pixel data.

FIG. 2B illustrates an example image and its related pixel data depicting a target oral care implement depicting target pixel data.

FIG. 2C illustrates an example image depicting degradation pixel data.

FIG. 2D illustrates an example image depicting target pixel data of a personal care implement.

FIG. 3 illustrates an example digital imaging and AI-based method for analyzing oral care implement degradation.

FIG. 4 illustrates an example digital imaging and AI-based method for analyzing oral care implement degradation including analyzing varied physical degradations at different time states across one or more expected oral care implement lifecycles.

FIG. 5A illustrates an example user interface as rendered on a display screen of a user computing device.

FIG. 5B illustrates a further example user interface as rendered on the display screen of a user computing device.

### DETAILED DESCRIPTION

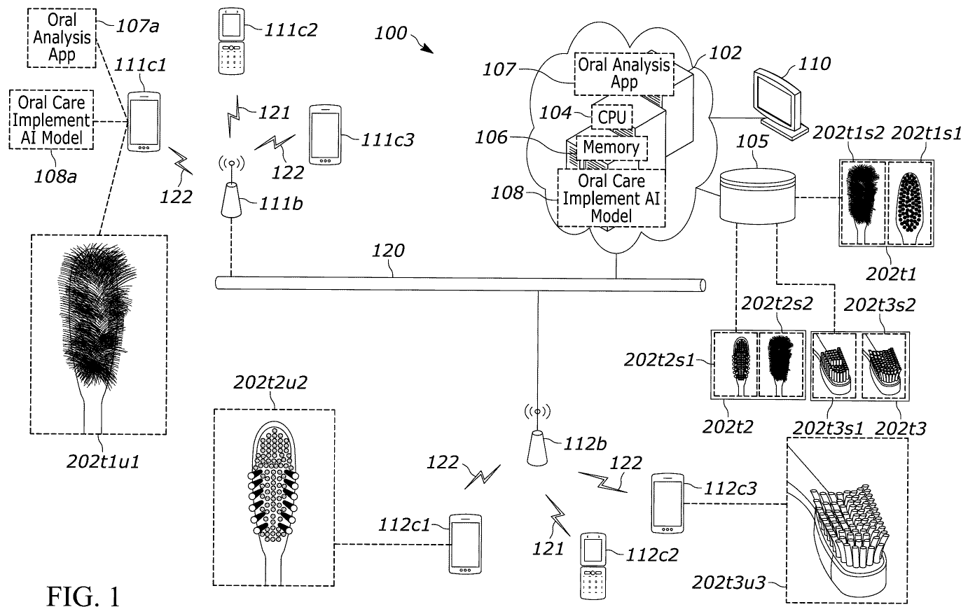

FIG. 1 illustrates an example digital imaging and artificial intelligence (AI)-based system 100 configured to analyze oral care implement degradation, in accordance with various embodiments disclosed herein. In the example embodiment of FIG. 1, digital imaging and AI-based system 100 includes server 102, which may comprise one or more computer servers. In various embodiments server 102 may comprise multiple servers, which may comprise multiple, redundant, or replicated servers as part of a server farm. In still further embodiments, server 102 may be implemented as cloud-based servers, such as a cloud-based computing platform. For example, imaging server 102 may be any one or more cloud-based platform(s) such as MICROSOFT AZURE, AMAZON AWS, or the like. Server 102 may include one or more processors 104 (i.e., CPU(s)) as well as a computer memory 106. In various embodiments, server 102 may be referred to herein as “imaging server(s).”

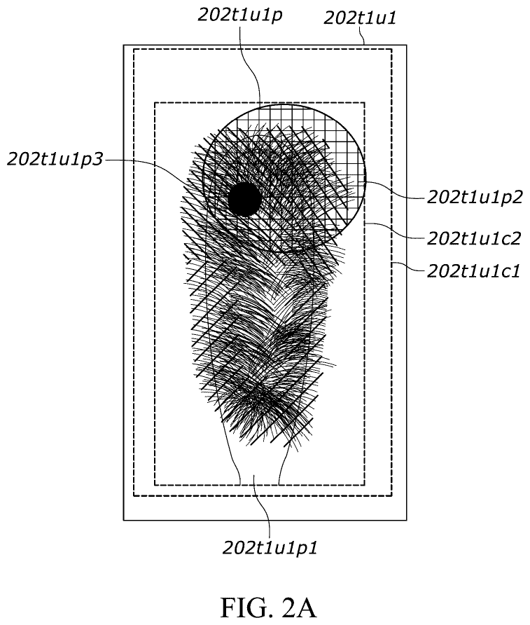

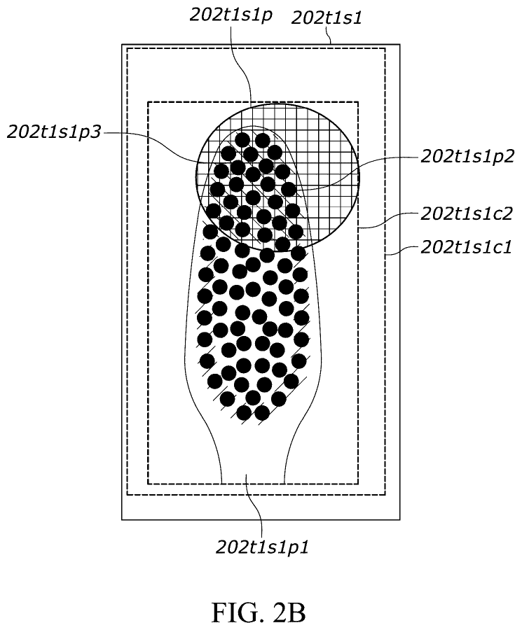

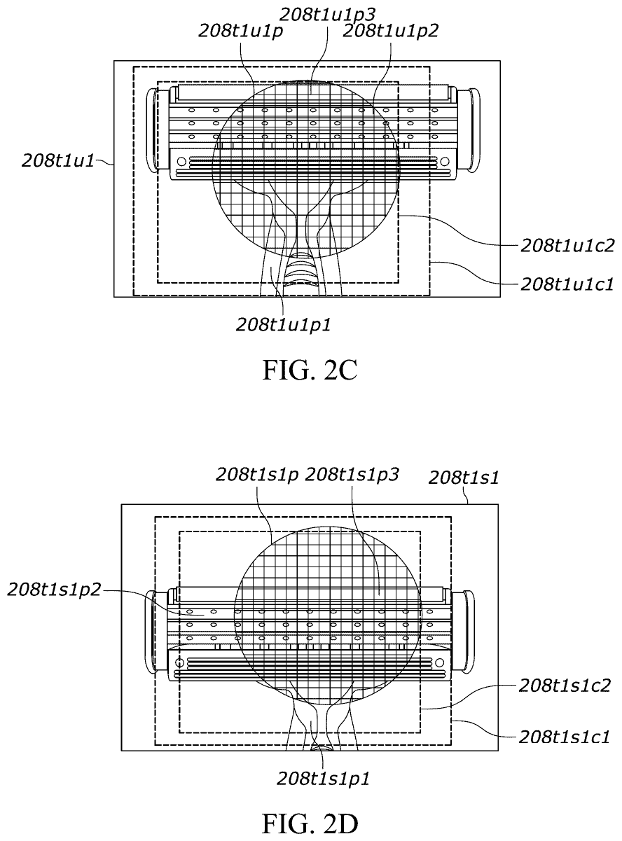

Memory 106 may include one or more forms of volatile and/or non-volatile, fixed and/or removable memory, such as read-only memory (ROM), electronic programmable read-only memory (EPROM), random access memory (RAM), erasable electronic programmable read-only memory (EEPROM), and/or other hard drives, flash memory, MicroSD cards, and others. Memory 106 may store an operating system (OS) (e.g., Microsoft Windows, Linux, UNIX, etc.) capable of facilitating the functionalities, apps, methods, or other software as discussed herein. Memory 106 may store an oral care implement AI model 108, which may comprise an artificial intelligence-based model, such as a machine learning model, trained on various images (e.g., images 202t1s1, 202t1s2, 202t2s1, 202t2s2, 202t3s1, 202t3s2), or otherwise described herein. Additionally, or alternatively, oral care implement AI model 108 may also be stored in database 105, which is accessible or otherwise communicatively coupled to imaging server 102. In addition, memory 106 may also store machine readable instructions, including any of one or more application(s) (e.g., an oral analysis application as described herein), one or more software component(s), and/or one or more application programming interfaces (APIs), which may be implemented to facilitate or perform the features, functions, or other disclosure described herein, such as any methods, processes, elements or limitations, as illustrated, depicted, or described for the various flowcharts, illustrations, diagrams, figures, and/or other disclosure herein. For example, at least some of the applications, software components, or APIs may be, include, otherwise be part of, a machine learning model or component, such as the oral care implement AI model 108, oral care implement AI model 108a, or, more generally a personal care implement model (e.g., for razors or grooming as shown for FIGS. 2C and 2D herein), where each may be configured to facilitate their various functionalities discussed herein. It should be appreciated that one or more other applications may be envisioned and that are executed by processor 104.

Processor 104 may be connected to memory 106 via a computer bus responsible for transmitting electronic data, data packets, or otherwise electronic signals to and from the processor 104 and memory 106 in order to implement or perform the machine-readable instructions, methods, processes, elements or limitations, as illustrated, depicted, or described for the various flowcharts, illustrations, diagrams, figures, and/or other disclosure herein.

Processor 104 may interface with memory 106 via the computer bus to execute an operating system (OS). Processor 104 may also interface with the memory 106 via the computer bus to create, read, update, delete, or otherwise access or interact with the data stored in memory 106 and/or the database 105 (e.g., a relational database, such as Oracle, DB2, MySQL, or a NoSQL based database, such as MongoDB). The data stored in memory 106 and/or database 105 may include all or part of any of the data or information described herein, including, for example, training images and/or user images (e.g., including any one or more of images 202t1s1, 202t1s2, 202t2s1, 202t2s2, 202t3s1, 202t3s2, 202t1u1, 202t2u2, 202t3u3, and/or zoomed, cropped, and/or segmentation related images for example as shown for FIGS. 2A, 2B, 2C, and/or 2D), and/or other images and/or information of products, care implements, or other information or data as otherwise described herein.

Imaging server 102 may further include a communication component configured to communicate (e.g., send and receive) data via one or more external/network port(s) to one or more networks or local terminals, such as computer network 120 and/or terminal 110 (for rendering or visualizing) described herein. In some embodiments, imaging server 102 may include a client-server platform technology such as ASP.NET, Java J2EE, Ruby on Rails, Node.js, a web service or online API, responsive for receiving and responding to electronic requests. The imaging server 102 may implement the client-server platform technology that may interact, via the computer bus, with the memory 106 (including the applications(s), component(s), API(s), data, etc. stored therein) and/or database 105 to implement or perform the machine readable instructions, methods, processes, elements or limitations, as illustrated, depicted, or described for the various flowcharts, illustrations, diagrams, figures, and/or other disclosure herein.

In various embodiments, the imaging server 102 may include, or interact with, one or more transceivers (e.g., WWAN, WLAN, and/or WPAN transceivers) functioning in accordance with IEEE standards, 3GPP standards, or other standards, and that may be used in receipt and transmission of data via external/network ports connected to computer network 120. In some embodiments, computer network 120 may comprise a private network or local area network (LAN). Additionally, or alternatively, computer network 120 may comprise a public network such as the Internet.

Imaging server 102 may further include or implement an operator interface configured to present information to an administrator or operator and/or receive inputs from the administrator or operator. As shown in FIG. 1, an operator interface may provide a display screen (e.g., via terminal 110). Imaging server 102 may also provide I/O components (e.g., ports, capacitive or resistive touch sensitive input panels, keys, buttons, lights, LEDs), which may be directly accessible via, or attached to, imaging server 102 or may be indirectly accessible via or attached to terminal 110. According to some embodiments, an administrator or operator may access the server 102 via terminal 110 to review information, make changes, input training data or images, initiate training of oral care implement AI model 108, and/or perform other functions.

As described herein, in some embodiments, imaging server 102 may perform the functionalities as discussed herein as part of a “cloud” network or may otherwise communicate with other hardware or software components within the cloud to send, retrieve, or otherwise analyze data or information described herein.

In general, a computer program or computer based product, application, or code (e.g., the model(s), such as AI models, or other computing instructions described herein) may be stored on a computer usable storage medium, or tangible, non-transitory computer-readable medium (e.g., standard random access memory (RAM), an optical disc, a universal serial bus (USB) drive, or the like) having such computer-readable program code or computer instructions embodied therein, wherein the computer-readable program code or computer instructions may be installed on or otherwise adapted to be executed by the processor 104 (e.g., working in connection with the respective operating system in memory 106) to facilitate, implement, or perform the machine readable instructions, methods, processes, elements or limitations, as illustrated, depicted, or described for the various flowcharts, illustrations, diagrams, figures, and/or other disclosure herein. In this regard, the program code may be implemented in any desired program language, and may be implemented as machine code, assembly code, byte code, interpretable source code or the like (e.g., via Golang, Python, C, C++, C#, Objective-C, Java, Scala, ActionScript, JavaScript, HTML, CSS, XML, etc.).

As shown in FIG. 1, imaging server 102 are communicatively connected, via computer network 120 to the one or more user computing devices 111c1-111c3 and/or 112c1-112c3 via base stations 111b and 112b. In some embodiments, base stations 111b and 112b may comprise cellular base stations, such as cell towers, communicating to the one or more user computing devices 111c1-111c3 and 112c1-112c3 via wireless communications 121 based on any one or more of various mobile phone standards, including NMT, GSM, CDMA, UMMTS, LTE, 5G, or the like. Additionally, or alternatively, base stations 111b and 112b may comprise routers, wireless switches, or other such wireless connection points communicating to the one or more user computing devices 111c1-111c3 and 112c1-112c3 via wireless communications 122 based on any one or more of various wireless standards, including by non-limiting example, IEEE 802.11a/b/c/g (WIFI), the BLUETOOTH standard, or the like.

Any of the one or more user computing devices 111c1-111c3 and/or 112c1-112c3 may comprise mobile devices and/or client devices for accessing and/or communications with imaging server 102. Such mobile devices may comprise one or more mobile processor(s) and/or an imaging device for capturing images, such as images as described herein (e.g., any one or more of images 202t1u1, 202t2u2, and/or 202t3u3). In various embodiments, user computing devices 111c1-111c3 and/or 112c1-112c3 may comprise a mobile phone (e.g., a cellular phone), a tablet device, a personal data assistance (PDA), or the like, including, by non-limiting example, an APPLE iPhone or iPad device or a GOOGLE ANDROID based mobile phone or table.

In various embodiments, the one or more user computing devices 111c1-111c3 and/or 112c1-112c3 may implement or execute an operating system (OS) or mobile platform such as Apple's iOS and/or Google's Android operation system. Any of the one or more user computing devices 111c1-111c3 and/or 112c1-112c3 may comprise one or more processors and/or one or more memories for storing, implementing, or executing computing instructions or code, e.g., a mobile application or a home or personal assistant application, as described in various embodiments herein. As shown in FIG. 1, oral care implement AI model 108a and/or oral analysis app 107a, or at least portions thereof, may also be stored locally on a memory of a user computing device (e.g., user computing device 111c1). In some aspects, oral care implement AI model 108a and/or oral analysis app 107a as installed on a computing device may comprise a same oral care implement AI model and/or oral analysis app as installed on server 102. Additionally, or alternatively, oral care implement AI model 108a and/or oral analysis app 107a may comprise a portion of the oral care implement AI model 108 and/or oral analysis app 107 as installed on server 102, where such respective models can communicate with each other across computer network 120. Further, it is to be understood that in some aspects, oral care implement AI model 108 and oral care implement AI model 108a may be installed wholly at user computing device, wholly at server 102, or partially on user computing device and partially on server 102 where communication between oral analysis app 107a and oral analysis app 107, and/or between oral care implement AI model 108 and oral care implement AI model 108a, occurs through computer network 120. Generally, when a given model or app is referred to herein, it refers respectively to one or both of the given app or model, whether operating alone at the sever or computing device, or whether communicating over computer network 120.

User computing devices 111c1-111c3 and/or 112c1-112c3 may comprise a wireless transceiver to receive and transmit wireless communications 121 and/or 122 to and from base stations 111b and/or 112b. In various embodiments, pixel-based images (e.g., images 202t1u1, 202t2u2, and/or 202t3u3) may be transmitted via computer network 120 to imaging server 102 for training of model(s) (e.g., an oral care implement AI model and/or personal care implement model) and/or for imaging analysis as described herein.

In the example of FIG. 1, images 202t1u1, 202t2u2, and/or 202t3u3 are user submitted images, which may comprise images of care implements (e.g., oral care implements) at later time states (e.g., usage at one to several days, weeks or months). Images 202t1s1, 202t2s1, and 202t3s1, represent reference images, which may comprise images of care implements (e.g., oral care implements) at new or unused time states. Images 202t1s2, 202t2s2, and 202t3s2 represent target images, which may comprise images of care implements (e.g., oral care implements) at later or used time states. Each of the images 202t1s1, 202t2s1, and 202t3s1 and 202t1s2, 202t2s2, and 202t3s2 are grouped into training sets 202t1, 202t2, and 202t3. The training sets can be used to train an oral care implement AI model and/or personal care implement model so that the AI model can learn to detect and output respective degradation values corresponding to the one or more oral care implements and their respective varied physical degradations at the different time states across the one or more expected oral care implement lifecycles.

It should be noted that the term “degradation” as used herein also describes or otherwise implies changes to corresponding oral care implement(s) (e.g., or other personal care implement(s)), including, for example respective varied physical changes (e.g., including changes from contaminants) at the different time states across the one or more expected oral care implement (or other personal care implement) lifecycles. Such changes may include, by way of non-limiting example, the addition of dust contamination in an oral care implement (e.g., such as a toothbrush) and/or hair or blood contamination on a personal care implement (e.g., such as a razor).

In addition, the one or more user computing devices 111c1-111c3 and/or 112c1-112c3 may include an imaging device (e.g., a camera) and/or digital video camera for capturing or taking digital images and/or frames (e.g., which can be any one or more of images 202t1u1, 202t2u2, and/or 202t3u3). Each digital image may comprise pixel data for training or implementing model(s), such as AI or machine learning models, as described herein. For example, an imaging device and/or digital video camera of, e.g., any of user computing devices 111c1-111c3 and/or 112c1-112c3, may be configured to take, capture, or otherwise generate digital images (e.g., pixel-based images 202t1u1, 202t2u2, and/or 202t 3u3) and, at least in some embodiments, may store such images in a memory of a respective user computing devices. Additionally, or alternatively, such digital images may also be transmitted to and/or stored on memory 106 and/or database 105 of server 102.

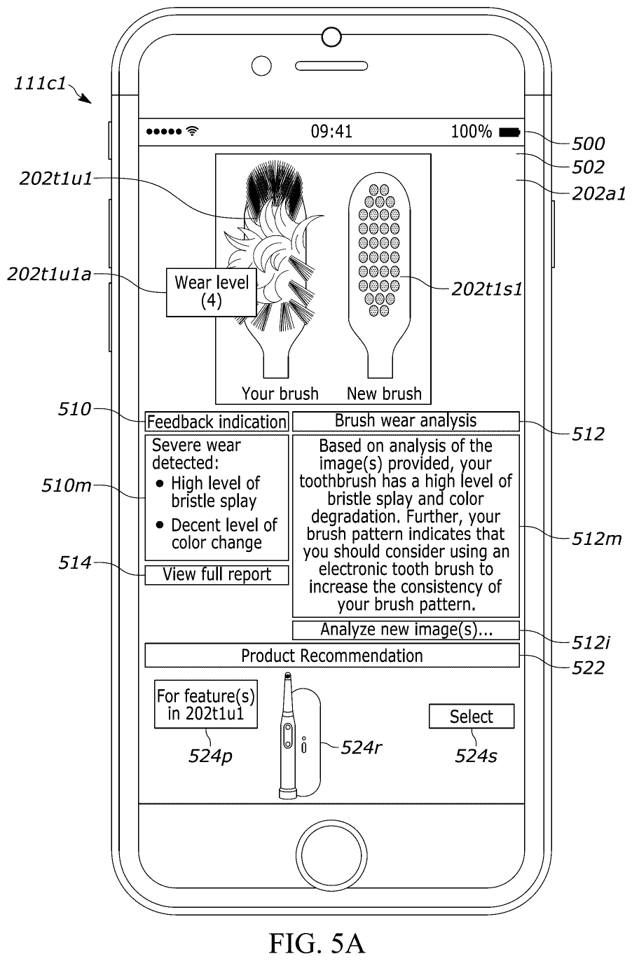

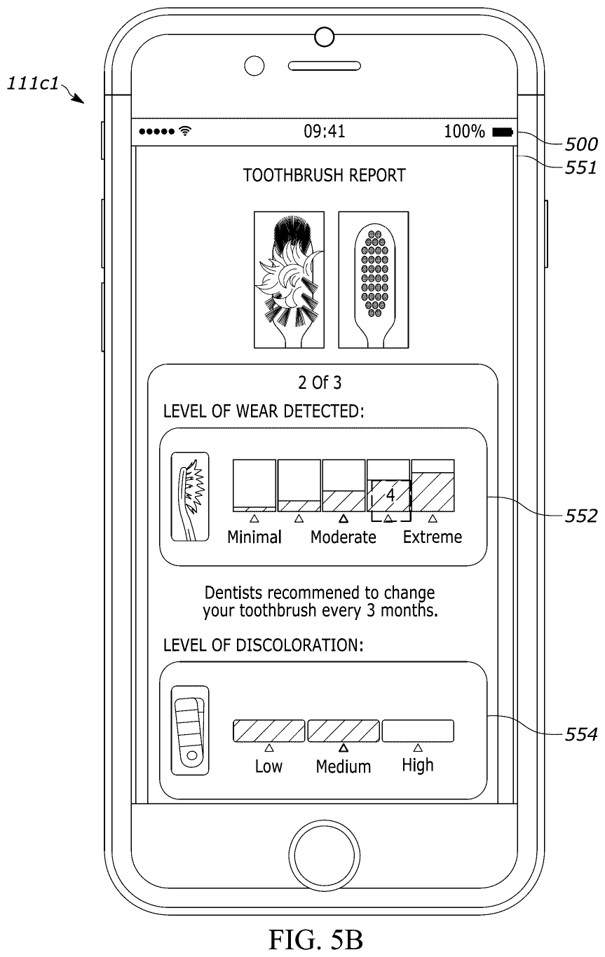

Still further, each of the one or more user computer devices 111c1-111c3 and/or 112c1-112c3 may include a display screen for displaying graphics, images, text, product(s), data, pixels, features, and/or other such visualizations or information as described herein. In various embodiments, graphics, images, text, product(s), data, pixels, features, and/or other such visualizations or information may be received from imaging server 102 for display on the display screen of any one or more of user computer devices 111c1-111c3 and/or 112c1-112c3. Additionally, or alternatively, a user computer device, e.g., as described herein for FIGS. 5A and 5B, may comprise, implement, have access to, render, or otherwise expose, at least in part, an interface or a guided user interface (GUI) for displaying text and/or images on its display screen.

In some embodiments, computing instructions and/or applications executing at the server (e.g., server 102) and/or at a mobile device (e.g., mobile device 111c1) may be communicatively connected for analyzing pixel data of an image of a care implement (e.g., an oral care implement of FIGS. 2A and/or 2B and/or a grooming care implement of FIGS. 2C and/or 2D) to generate or otherwise output a feedback indication(s) designed to address features identifiable within the pixel data comprising the care implement, as described herein. For example, one or more processors (e.g., processor 104) of server 102 may be communicatively coupled to a mobile device via a computer network (e.g., computer network 120). In such embodiments, an app (e.g., oral analysis app 107) may comprise a server app portion configured to execute on the one or more processors of the server (e.g., server 102) and a mobile app portion (e.g., oral analysis app 107a) configured to execute on one or more processors of the mobile device (e.g., any of one or more user computing devices 111c1-111c3 and/or 112c1-112c3). In such embodiments, the server app portion is configured to communicate with the mobile app portion. The server app portion or the mobile app portion may each be configured to implement, or partially implement, one or more of: (1) obtain the set of one or more images of the oral care implement of the user (202t1u1); (2) detect the type of the oral care implement; (3) input into the oral care implement AI model (e.g., 108 and/or 108a) the type of the oral care implements and/or the one or more images of the oral care implement; (4) generate, based on the output of the user-specific degradation value, the user-specific degradation analysis (see, e.g., FIG. 5A) for the oral care implement; and/or (5) output, based on the user-specific degradation analysis, the feedback indication (see, e.g., FIG. 5A) designed to address at least one feature identifiable within the pixel data depicting the physical features of the oral care implement.

FIG. 2A illustrates an example image 202t1u1 and its related pixel data depicting an oral care implement depicting degradation pixel data, which may be used for training and/or implementing an oral care implement AI model, in accordance with various embodiments disclosed herein. In various embodiments, as shown for FIG. 2A, image 202t1u1 may be an image captured by a user. More generally, images 202t1u1 and 202t1u2 may be transmitted to server 102 via computer network 120, as shown for FIG. 1. It is to be understood that such images may be captured by the users themselves or, additionally or alternatively, others, where such images are used and/or transmitted on behalf of a user.

Still further, digital images, such as non-limiting example images 202t1u1 and/or 202t1u2, may be collected or aggregated at imaging server 102 and may be analyzed by, and/or used to train, an AI-based model (e.g., an AI model such as a machine learning imaging model as described herein). These images may include of depicting one or more oral care implements comprising one or more types and having varied physical degradations at different time states (e.g., including 202t1s1, 202t1s2, 202t2s1, 202t2s2, 202t3s1, 202t3s2) across one or more expected oral care implement lifecycles. Each of these images may comprise pixel data comprising feature data and corresponding to oral care implements, personal care implements, their related components, and/or other features described herein. The pixel data may be captured by an imaging device (e.g., a camera) of one of the user computing devices (e.g., one or more user computer devices 111c1-111c3 and/or 112c1-112c3).

With respect to digital images as described herein, pixel data (e.g., pixel data of any of the images described herein) comprises individual points or squares of data within an image, where each point or square represents a single pixel (e.g., each of pixel 202t1u1p1, pixel 202t1u1p2, and pixel 202t1u1p3) within an image. Each pixel may be at a specific location within an image. In addition, each pixel may have a specific color (or lack thereof). Pixel color may be determined by a color format and related channel data associated with a given pixel. For example, a popular color format is a 1976 CIELAB (also referenced herein as the “CIE L*-a*-b*” or simply “L*a*b*” color format) color format that is configured to mimic the human perception of color. Namely, the L*a*b* color format is designed such that the amount of numerical change in the three values representing the L*a*b* color format (e.g., L*, a*, and b*) corresponds roughly to the same amount of visually perceived change by a human. This color format is advantageous, for example, because the L*a*b* gamut (e.g., the complete subset of colors included as part of the color format) includes the gamuts of Red (R), Green (G), and Blue (B) (collectively RGB) and Cyan (C), Magenta (M), Yellow (Y), and Black (K) (collectively CMYK) color formats.

In the L* a* b* color format, color is viewed as point in three dimensional space, as defined by the three-dimensional coordinate system (L*, a*, b*), where each of the L* data, the a* data, and the b* data may correspond to individual color channels, and may therefore be referenced as channel data. In this three-dimensional coordinate system, the L* axis describes the brightness (luminance) of the color with values from 0 (black) to 100 (white). The a* axis describes the green or red ratio of a color with positive a* values (+a*) indicating red hue and negative a* values (−a*) indicating green hue. The b* axis describes the blue or yellow ratio of a color with positive b* values (+b*) indicating yellow hue and negative b* values (−b*) indicating blue hue. Generally, the values corresponding to the a* and b* axes may be unbounded, such that the a* and b* axes may include any suitable numerical values to express the axis boundaries. However, the a* and b* axes may typically include lower and upper boundaries that range from approximately 150to −150 . Thus, in this manner, each pixel color value may be represented as a three-tuple of the L*, a*, and b* values to create a final color for a given pixel.

As another example, a popular color format includes the red-green-blue (RGB) format having red, green, and blue channels. That is, in the RGB format, data of a pixel is represented by three numerical RGB components (Red, Green, Blue), that may be referred to as channel data, to manipulate the color of pixel's area within the image. In some implementations, the three RGB components may be represented as three 8-bit numbers for each pixel. Three 8-bit bytes (one byte for each RGB value) may be used to generate 24-bit color. Each 8-bit RGB component can have 256 possible values, ranging from 0 to 255 (i.e., in the base 2 binary system, an 8-bit byte can contain one of 256 numeric values ranging from 0 to 255). This channel data (R, G, and B) can be assigned a value from 0 to 255 that can be used to set the pixel's color. For example, three values like (250, 165, 0), meaning (Red=250, Green=165, Blue=0), can denote one Orange pixel. As a further example, (Red=255, Green=255, Blue=0) means Red and Green, each fully saturated (255 is as bright as 8 bits can be), with no Blue (zero), with the resulting color being Yellow. As a still further example, the color black has an RGB value of (Red=0, Green=0, Blue=0) and white has an RGB value of (Red=255, Green=255, Blue=255). Gray has the property of having equal or similar RGB values, for example, (Red=220, Green=220, Blue=220) is a light gray (near white), and (Red=40, Green=40, Blue=40) is a dark gray (near black).

In this way, the composite of three RGB values creates a final color for a given pixel. With a 24-bit RGB color image, using 3 bytes to define a color, there can be 256 shades of red, 256 shades of green, and 256 shades of blue. This provides 256×256×256, i.e., 16.7 million possible combinations or colors for 24-bit RGB color images. As such, a pixel's RGB data value indicates the degree of color or light each of a Red, a Green, and a Blue pixel is comprised of. The three colors, and their intensity levels, are combined at that image pixel, i.e., at that pixel location on a display screen, to illuminate a display screen at that location with that color. It is to be understood, however, that other bit sizes, having fewer or more bits, e.g., 10-bits, may be used to result in fewer or more overall colors and ranges.

As a whole, the various pixels, positioned together in a grid pattern (e.g., pixel data 202t1u1p), form a digital image or portion thereof. A single digital image can comprise thousands or millions of pixels. Images can be captured, generated, stored, and/or transmitted in a number of formats, such as JPEG, TIFF, PNG and GIF. These formats use pixels to store or represent the image.

With reference to FIG. 2A, example image 202t1u1 illustrates an oral care implement (e.g., a toothbrush) depicting physical degradation at a given time state, e.g., at or around three months of use. More specifically, image 202t1u1 comprises pixel data, including pixel data 202t1u1p defining a handle, or region of a handle, of the oral care implement (e.g., the toothbrush). Pixel data 202t1u1p includes a plurality of pixels including pixel 202t1u1p1, pixel 202t1u1p2, and pixel 202t1u1p3. In example image 202t1u1, each of pixel 202t1u1p1, pixel 202t1u1p2, and pixel 202t1u1p3 are representative of features of an oral care implement defining or otherwise corresponding to oral care implement data or otherwise pixel data depicting a type of oral care implement and a physical degradation value or otherwise characteristics at given time state (e.g., three months'time). Generally, in various embodiments, oral care implement data or otherwise pixel data may comprise one or more features identifiable with the pixel data of a given image. Each of these features may be determined from or otherwise based on one or more pixels in a digital image (e.g., image 202t1u1). For example, with respect to image 202t1u1, pixel 202t1u1p1 may be a relatively white pixel (e.g., pixels with relatively high RGB values across all RGB channels) positioned within pixel data 202t1u1p defining a white or otherwise light colored handle of the given oral care implement of FIG. 2A, which may be indicative of a particular type (e.g., a make or model) of oral care implement. The pixels may form a pattern in the shape of a handle of the oral care implement (e.g., a known handle of the type of oral care implement).

Pixel 202t1u1p2 may comprise a relatively light blue pixel (e.g., a pixel with a higher B (blue) value in RGB based channels relative to the G (green) and R (red) values, thereby indicating a light blue color). The light blue color may be indicative of a typical color associated with a brush color for a type of oral care implement (e.g., the toothbrush type is typically associated with a light blue color on the edge). As a further example, pixel 202t1u1p2 may also be part of a pattern of pixels defining an edge of the oral care implement (e.g., an edge of the bristles of the toothbrush), which can be used to determine and/or predict the degradation and/or the time state of the oral care implement. In some aspects, such shape, pattern, or edge may be used by a segmentation model to determine or detect an area that contains the edge of the oral care product (e.g., bristles of the toothbrush). For example, image preprocessing can be implemented where the images are analyzed by a segmentation model to isolate or otherwise detect the pixels in the bristles area from the brush head. In the example of FIG. 2A, pixel 202t1u1p2 comprises a pixel in a pattern along the edge of an oral care implement defining the bristles of the toothbrush. The pixel, and the other pixels of the edge or pattern, define an irregular, non-structured edge of the toothbrush indicating that the bristles are splayed or otherwise worn. In this way such pixels, including pixel 202t1u1p2, indicate physical degradation of the oral care implement of FIG. 2A, which can be used to predict that the oral care implement is in a later stage time state (e.g., several months of use).

As a further example, pixel 202t1u1p3, which is located in the interior of the toothbrush bristles, may comprise a darker pixel (e.g., with lower values in the RGB based channels) in a uniform color with surrounding pixels, which may be indicative of a fraying within the interior of the toothbrush bristles that would otherwise be in a defined and discrete pattern if the tooth brush were newer (e.g., discrete patterns including pixel 202ts1p3 as shown for FIG. 2B). Thus, the uniform or blending of pixel 202t1u1p3 having a same color with other pixels in a same region as pixel 202t1u1p3 can indicate physical degradation of the oral care implement of FIG. 2A, which can be used to predict that the oral care implement is in a later stage time state (e.g., several months of use).

In this way, each of pixel 202t1u1p1, 202t1u1p2, and 202t1u1p3 defines features that comprise pixel data that may be used to train oral care implement AI model (e.g., train oral care implement AI model 108) to output respective degradation values corresponding to the one or more oral care implements and their respective varied physical degradations at the different time states across the one or more expected oral care implement lifecycles.

In addition to pixels 202t1u1p1, 202t1u1p2, and 202t1u1p3, pixel data 202t1u1p includes various other pixels including remaining portions of the oral care implement (e.g., the toothbrush), including various other pixels that may be analyzed and/or used for training of model(s), and/or analysis by used of already trained models, such as oral care implement AI model 108 and/or oral care implement AI model 108a as described herein. For example, pixel data 202t1u1p further includes pixels representative of features of further irregular edges, patterns (e.g., patterns of wear reflecting use of the toothbrush), or otherwise fraying of bristles indicating degradation, faded colors indicating degradation, offset bristles from one another indicating degradation, and/or other features identified in the pixel data and/or at a particular location in the image, where such pixels comprise unique identifiable features, which provides training information for outputting respective degradation values corresponding to the one or more oral care implements and their respective varied physical degradations at the different time states across the one or more expected oral care implement lifecycles, e.g., as described herein. Still further, in additional examples, pixel data 202t1u1p may also depict degradations, such as changes, to the oral care implement (e.g., the toothbrush), which may comprise, by way of non-limiting example, contaminants identified in the pixel data indicating debris, dust, bacteria, particulates, or otherwise residue, for example, collected within the brush head of the oral care implement. Such features identified in the pixel data and/or at a particular location in the image (e.g., within the bristles) can comprise unique identifiable features, which provides training information for outputting respective degradation values (e.g., changes) corresponding to the one or more oral care implements and their respective varied physical degradations (e.g., physical changes) at the different time states across the one or more expected oral care implement lifecycles, and which may be used to train an AI model (e.g., oral care implement AI model 108) as described herein. In one example, an AI model trained with such features can be configured to output a feedback indication that recommends a particular toothpaste for paring with the oral care implement in order to decrease risk of oral conditions for the user's gum, thereby providing a source of treatment specific to the user. In another example, the AI model trained with such features can be configured to output a feedback indication that recommends a particular toothbrush for the user in order to decrease risk of scratching the user's gums, enamel, or otherwise causing other oral conditions for the user, thereby providing a source of treatment specific to the user.

A digital image, such as a training image, an image as submitted by users, or otherwise a digital image (e.g., any of images 202t1u1p1, 202t1u1p2, 202t1u1p3, 202t1s1, 202t1s2, 202t2s1, 202t2s2, 202t3s1, 202t3s2, 202t1u1, 202t2u2, and 202t3u3), may be or may comprise a cropped image. Generally, a cropped image is an image with one or more pixels removed, deleted, or hidden from an originally captured image. In some aspects, each image of the one or more of the plurality of training images e.g., any of images 202t1u1p1, 202t1u1p2, 202t1u1p3, 202t1s1, 202t1s2, 202t2s1, 202t2s2, 202t3s1, 202t3s2, 202t1u1, 202t2u2, and 202t3u3) or the image of a care implement and/at least one cropped image depicting the care implement having a given feature. For example, with reference to FIG. 2A, cropped portion 202t1u1c1 represents a first cropped portion of image 202t1u1 that removes portions of the background or non-product features (outside of cropped portion 202t1u1c1) that may not include readily identifiable regions that have a care implement and/or care implement features. As a further example, cropped portion 202t1u1c2 represents a second cropped portion of image 202t1u1 that removes further portions of the image (outside of cropped portion 202t1u1c2) that includes additional background or non-product features compared to the cropped portion 202t1u1c1, and therefore reduces the amount of pixels and data that the give system (e.g., system 100) must store or otherwise analyze as training data.

In various embodiments, analyzing and/or use of cropped images for training yields improved accuracy of a training the learning models (e.g., an oral care implement AI model). It also improves the efficiency and performance of the underlying computer system in that such system processes, stores, and/or transfers smaller size digital images. Furthermore, images may be sent as cropped or that otherwise include extracted or depicted care implement without depicting personal identifiable information (PII) of a user. In some aspects, each image of a plurality of training images may comprise at least one cropped image removing at least a portion of PII of a user. For example, a cropping algorithm automatically crops each item in the image (if more than one is presented), to check and crop out human/facial accidental images (e.g., a mirror reflection) and remove such PII data. Such cropped images provide a security improvement, i.e., where the removal of PII provides an improvement over prior systems because cropped or redacted images, especially ones that may be transmitted over a network (e.g., the Internet), are more secure without including PII information of a user. Importantly, the systems and methods described herein may operate without the need for such non-essential information and thus is able to operate with smaller data size images, which provides an improvement, e.g., a security and a performance improvement, over conventional systems.

Imaging cropping may be performed for any image(s) described herein, including for the images of FIGS. 2A, 2B, 2C, and/or 2D. Moreover, while FIGS. 2A-2D may depict and describe a cropped image, it is to be understood, however, that other image types including, but not limited to, original, non-cropped images (e.g., original image 202t1u1) and/or other types/sizes of cropped images may be used or substituted as well.

FIG. 2B illustrates an example image 202t1s1 and its related pixel data depicting a target oral care implement depicting target pixel data, which may be used for training and/or implementing an oral care implement AI model (e.g., such as the oral care implement AI model of FIG. 2A), in accordance with various embodiments disclosed herein. In various embodiments, as shown for FIG. 2B, image 202t1s1 may be an image captured by an oral care implement manufacturer. More generally, image 202t1s1 (as well as images 202t1u2 and 202t1u2) may be an image that was captured by the manufacturer of the oral care implement to reflect a new state of the oral care implement. Such images may be stored in database 105 and/or memory 106 by the manufacturer for training an oral care implement AI model (e.g., an oral care implement AI model 108) as described herein.

With reference to FIG. 2B, example image 202t1s1 illustrates an oral care implement (e.g., a toothbrush) depicting physical degradation at a given time state, e.g., a new state or relatively unused state of use. More specifically, image 202t1s1 comprises pixel data, including pixel data 202t1s1p defining a handle, or region of a handle, of the oral care implement (e.g., the toothbrush). Pixel data 202t1s1p includes a plurality of pixels including pixel 202t1s1p1, pixel 202t1s1p2, and pixel 202t1s1p3. In example image 202t1s1, each of pixel 202t1s1p1, pixel 202t1s1p2, and pixel 202t1s1p3 are representative of features of an oral care implement defining or otherwise corresponding to oral care implement data or otherwise pixel data depicting a type of oral care implement and a physical degradation value or otherwise characteristics at given time state (e.g., zero time or low usage time). Generally, in various embodiments, oral care implement data or otherwise pixel data may comprise one or more features identifiable with the pixel data of a given image. Each of these features may be determined from or otherwise based on one or more pixels in a digital image (e.g., image 202t1s1). For example, with respect to image 202t1s1, pixel 202t1s1p1 may be a relatively white pixel (e.g., pixels with relatively high RGB values across all RGB channels) positioned within pixel data 202t1s1p defining a white or otherwise light-colored handle of the given oral care implement of FIG. 2B, which may be indicative of a particular type of oral care implement. The pixels may form a pattern in the shape of a handle of the oral care implement (e.g., a known handle of the type of oral care implement).

Still further, with respect to pixel 202t1s1p1, the pixel may be further distanced from the bristles of the lower edge of the oral care implement when compared to pixel 202t1u1p1 of the oral care implement of FIG. 2A. Such distancing may indicate that the oral care implement depicted in FIG. 2A has no or less degradation and/or is at a newer time state compared to the oral care implement in FIG. 2B.

Pixel 202t1s1p2 may comprise a dark blue pixel (e.g., a pixel with a high B (blue) value in RGB based channels relative to the G (green) and R (red) values, thereby indicating a dark blue color). The dark blue color may be indicative of a typical color associated with a brush color for a type of oral care implement (e.g., the toothbrush type is typically associated with a dark blue color pattern on the edge). As a further example, pixel 202t1s1p2 may also be part of a pattern of pixels defining an edge of the oral care implement (e.g., an edge of the bristles of the toothbrush), which can be used to determine and/or predict the degradation and/or the time state of the oral care implement. In some aspects, such shape, pattern, or edge may be used by a segmentation model to determine or detect an area that contains the edge of the oral care implement (e.g., bristles of the toothbrush). For example, image preprocessing can be implemented where the images are analyzed by a segmentation model to isolate or otherwise detect the pixels in the bristles area from the brush head. In the example of FIG. 2B, pixel 202t1s1p2 comprises a pixel in a pattern along the edge of an oral care implement defining the bristles of the toothbrush. The pixel, and the other pixels of the edge or pattern, define a regular, structured edge of the toothbrush indicating that the bristles are closely formed or otherwise new. In this way such pixels, including pixel 202t1s1p2, indicate physical degradation of the oral care implement of FIG. 2B, which can be used to predict that the oral care implement is in a newer stage time state (e.g., new or low usage).

As a further example, pixel 202t1s1p3, which is located in the interior of the toothbrush bristles, may comprise a darker pixel (e.g., with higher values in the RGB based channels) in a structured color compared to surrounding pixels with lighter colors, which may be indicative of a tight grouping of bristles within the interior of the toothbrush that defines a discrete pattern indicating that the tooth brush is newer or low usage (e.g., discrete patterns including pixel 202ts1p3). Thus, the structure color or pattern of pixel 202t1s1p3 having a different color with other pixels in a same region as pixel 202t1s1p3 can indicate no or low physical degradation of the oral care implement of FIG. 2B, which can be used to predict that the oral care implement is in a newer stage time state (e.g., new or low usage).

In this way, each of pixel 202t1s1p1, 202t1s1p2, and 202t1s1p 3 defines features that comprise pixel data that may be used to train oral care implement AI model (e.g., train oral care implement AI model 108) to output respective degradation values corresponding to the one or more oral care implements and their respective varied physical degradations at the different time states across the one or more expected oral care implement lifecycles.

In addition to pixels 202t1s1p1, 202t1s1p2, and 202t1s1p3, pixel data 202t1s1p includes various other pixels including remaining portions of the oral care implement t (e.g., the toothbrush), including various other pixels that may be analyzed and/or used for training of model(s), and/or analysis by used of already trained models, such as oral care implement AI model 108 and/or oral care implement AI model 108a as described herein. For example, pixel data 202t1s1p further includes pixels representative of features of further regular edges, patterns, or otherwise tightly grouped bristles indicating no or low degradation, bright colors indicating no or low degradation, bristles grouped together in patterns indicating degradation, and/or other features identified in the pixel data and/or at a particular location in the image, where such pixels comprise unique identifiable features, which provides training information for outputting respective degradation values corresponding to the one or more oral care implements and their respective varied physical degradations at the different time states across the one or more expected oral care implement lifecycles, e.g., as described herein.

In addition, digital images of care implements, e.g., as described herein, may depict various features, which may be used to train an AI model (e.g., oral care improvement AI model) across a variety of different care implements (e.g., oral care implements) having a variety of different product features. For example, as illustrated for images 202t1u1, 202tu2, and 202t3u3, the product features of these different care implements can be different, where, for example the care implements can have different types, shapes, colors, edges, patterns, and/or the like. In addition, FIGS. 2C and 2D illustrate an example personal care implement (e.g., a razor), which be used to train an AI model that can identify types and/or degradations of razors.

The image 202t1s1 may also be cropped for comparison or otherwise analysis as described herein. In the example of FIG. 2B, cropped portion 202t1s1c1 represents a first cropped portion of image 202t1s1 that removes portions of the background or non-product features (outside of cropped portion 202t1s1c1) that may not include readily identifiable regions that have a care implement and/or care implement features. As a further example, cropped portion 202t1s1c2 represents a second cropped portion of image 202t1s1 that removes further portions of the image (outside of cropped portion 202t1s1c2) that includes additional background or non-product features compared to the cropped portion 202t1s1c1, and therefore reduces the amount of pixels and data that the give system (e.g., system 100) must store or otherwise analyze as training data.

FIG. 2C illustrates an example image and its related pixel data depicting a personal care implement depicting degradation pixel data, which may be used for training and/or implementing a personal care implement AI model, in accordance with various embodiments disclosed herein. In various embodiments, as shown for FIG. 2C, image 208t1u1 may be an image captured by a user. More generally, image 208t1u1 may be transmitted to server 102 via computer network 120, as shown for FIG. 1. It is to be understood that such images may be captured by the users themselves or, additionally or alternatively, others, where such images are used and/or transmitted on behalf of a user.

With reference to FIG. 2C, example image 208t1u1 illustrates a personal care implement (e.g., a shaving razor) depicting physical degradation at a given time state, e.g., five months of use. More specifically, image 208t1u1 comprises pixel data, including pixel data 208t1u1p defining a handle, or region of a handle, of the personal care implement (e.g., the shaving razor). Pixel data 208t1u1p includes a plurality of pixels including pixel 208t1u1p1, pixel 208t1u1p2, and pixel 208t1u1p3. In example image 208t 1u1, each of pixel 208t1u1p1, pixel 208t1u1p2, and pixel 208t1u1p3 are representative of features of a personal care implement defining or otherwise corresponding to personal care implement data or otherwise pixel data depicting a type of personal care implement and a physical degradation value or otherwise characteristics at given time state (e.g., five months'time). Generally, in various embodiments, personal care implement data or otherwise pixel data may comprise one or more features identifiable with the pixel data of a given image. Each of these features may be determined from or otherwise based on one or more pixels in a digital image (e.g., image 208t1u1). For example, with respect to image 208t1u1, pixel 208t1u1p1 may be a relatively green pixel (e.g., pixels with a relatively high G (green) value across all RGB channels) positioned within pixel data 208t1u1p defining a green colored handle of the given personal care implement of FIG. 2C, which may be indicative of a particular type of personal care implement. The pixels may form a pattern in the shape of a handle of the personal care implement (e.g., a known handle of the type of personal care implement).

Pixel 208t1u1p2 may comprise a relatively metallic or silver pixel (e.g., a pixel with a RGB values (e.g., 192, 192, 192) for each RGB based channel giving a silver or otherwise metallic color). The metallic color may be indicative of a typical color associated with a cutting razor for a type of personal care implement. As a further example, pixel 208t1u1p2 may also be part of a pattern of pixels defining multiple cutting razors of the personal care implement (e.g., the shaving razor type is typically associated with three cutting razors defined by metallic pixels patterns in a straight orientation), which can be used to determine and/or predict the degradation and/or the time state of the personal care implement. In some aspects, such shape, pattern, or edge may be used by a segmentation model to determine or detect an area that contains the edge of the cutting razor (e.g., the cutting edge of the shaving razor). For example, image preprocessing can be implemented where the images are analyzed by a segmentation model to isolate or otherwise detect the pixels in the cutting razor area from the razor head. In the example of FIG. 2C, pixel 208t1u1p2 comprises a pixel in a pattern of a cutting razor of the personal care implement, where the edge of the cutting razor defines the sharpness of the razor. The pixel, and the other pixels of the edge or pattern, define a chipped, notched, or otherwise irregular cutting edge of the shaving razor indicating that the cutting razor is dulled or otherwise degraded. In this way such pixels, including pixel 208t1u1p2, indicate physical degradation of the personal care implement of FIG. 2C, which can be used to predict that the personal care implement is in a later stage time state (e.g., several months of use).

As a further example, pixel 208t1u1p3, which is located on a top portion of the shaving razor, may comprise a darker pixel (e.g., with lower values in the RGB based channels) in a rectangular shape with surrounding pixels, which may be indicative of a strip of the shaving razor used for hydration, exfoliation, or other purposes as the razor moves across a user's skin. In the example of FIG. 2C, the strip may be torn, discolored, or otherwise malformed indicating physical degradation of the personal care implement of FIG. 2C, which can be used to predict that the personal care implement is in a later stage time state (e.g., several months of use).

In this way, each of pixel 208t1u1p1, 208t1u1p2, and 208t1u1p3 defines features that comprise pixel data that may be used to train personal care implement AI model (e.g., train a personal care implement AI model, such as described herein for oral care implement AI model 108), to output respective degradation values corresponding to the one or more personal care implements and their respective varied physical degradations at the different time states across the one or more expected personal care implement lifecycles.

In addition to pixels 208t1u1p1, 208t1u1p2, and 208t1u1p3, pixel data 208t1u1p includes various other pixels including remaining portions of the personal care implement (e.g., the shaving razor), including various other pixels that may be analyzed and/or used for training of model(s), and/or analysis by used of already trained models, such as a personal care implement AI model. For example, pixel data 208t1u1p further includes pixels representative of features of further irregular edges, patterns, or otherwise dulled or noted areas of cutting razors, faded colors indicating degradation, hair stuck between the cutting razors indicating use or degradation, and/or other features identified in the pixel data and/or at a particular location in the image, where such pixels comprise unique identifiable features, which provides training information for outputting respective degradation values corresponding to the one or more personal care implements and their respective varied physical degradations at the different time states across the one or more expected personal care implement lifecycles, e.g., as described herein. Still further, in additional examples, pixel data 202t1u1p may also depict degradations, such as changes, to the personal care implement (e.g., the shaving razer), which may comprise, by way of non-limiting example, contaminants identified in the pixel data indicating debris, dust, bacteria, blood, hair, particulates, or otherwise residue, for example, collected within the razor head, exfoliating pad, or other portion of the personal care implement. Such features identified in the pixel data and/or at a particular location in the image (e.g., within or on the blades of the razor head) can comprise unique identifiable features, which provides training information for outputting respective degradation values (e.g., changes) corresponding to the one or more oral care implements and their respective varied physical degradations (e.g., physical changes) at the different time states across the one or more expected personal care implement lifecycles, and which may be used to train an AI model (e.g., a personal care implement AI model) as described herein. In one example, an AI model trained with such features can be configured to output a feedback indication that recommends a particular razor or shaving cream for paring with the oral care implement in order to decrease risk of skin conditions (e.g., razor burn) for the user's skin, thereby providing a source of treatment specific to the user.

The image 208t1u1 may also be cropped for comparison or otherwise analysis as described herein. In the example of FIG. 2C, cropped portion 208t1u1c1 represents a first cropped portion of image 208t1u1 that removes portions of the background or non-product features (outside of cropped portion 208t1u1c1) that may not include readily identifiable regions that have a care implement and/or care implement features. As a further example, cropped portion 208t1u1c2 represents a second cropped portion of image 208t1u1 that removes further portions of the image (outside of cropped portion 208t1u1c2) that includes additional background or non-product features compared to the cropped portion 208t1u1c1, and therefore reduces the amount of pixels and data that the give system (e.g., system 100) must store or otherwise analyze as training data.

FIG. 2D illustrates an example image and its related pixel data depicting a target personal care implement depicting target pixel data, which may be used for training and/or implementing a personal care implement AI model (e.g., such as the personal care implement AI model of FIG. 2C), in accordance with various embodiments disclosed herein. In various embodiments, as shown for FIG. 2D, image 208t1s1 may be an image captured by a personal care implement manufacturer. More generally, image 208t1s1 may be an image that was captured by the manufacturer of the oral care implement to reflect a new state of the personal care implement. Such images may be stored in database 105 and/or memory 106 by the manufacturer for training a personal care implement AI model.

With reference to FIG. 2D, example image 208t1s1 illustrates a personal care implement (e.g., a shaving razor) depicting no or low physical degradation at a given time state, e.g., a new razor at a first-time state. More specifically, image 208t1s1 comprises pixel data, including pixel data 208t1s1p defining a head, or region of a head, of the personal care implement (e.g., the shaving razor). Pixel data 208t1s1pincludes a plurality of pixels including pixel 208t1s1p1, pixel 208t1s1p2, and pixel 208t1s1p3. In example image 208t1s1, each of pixel 208t1s1p1, pixel 208t1s1p2, and pixel 208t1s1p3 are representative of features of a personal care implement defining or otherwise corresponding to personal care implement data or otherwise pixel data depicting a type of personal care implement and a physical degradation value or otherwise characteristics at given time state (e.g., a new time state). Generally, in various embodiments, personal care implement data or otherwise pixel data may comprise one or more features identifiable with the pixel data of a given image. Each of these features may be determined from or otherwise based on one or more pixels in a digital image (e.g., image 208t1s1). For example, with respect to image 208t1s1, pixel 208t1s1p1 may be a relatively green pixel (e.g., pixels with a relatively high G (green) value across all RGB channels) positioned within pixel data 208t1s1p defining a green colored handle of the given personal care implement of FIG. 2D, which may be indicative of a particular type of personal care implement. The pixels may form a pattern in the shape of a handle of the personal care implement (e.g., a known handle of the type of personal care implement).

Still further, with respect to pixel 208t1s1p1, the pixel indicate that the handle is new such that the plastic or rubber of the handle may have brighter colors or have fewer irregularities in shape when compared to pixel 208t1u1p1 of the personal care implement of FIG. 2C. Such fewer irregularities may indicate that the personal care implement depicted in FIG. 2D has no or less degradation and/or is at a newer time state compared to the oral care implement in FIG. 2C.

Pixel 208t1s1p2 may comprise a relatively metallic or silver pixel (e.g., a pixel with a RGB values (e.g., 192, 192, 192) for each RGB based channel giving a silver or otherwise metallic color). The metallic color may be indicative of a typical color associated with a cutting razor for a type of personal care implement. As a further example, pixel 208t1s1p2 may also be part of a pattern of pixels defining multiple cutting razors of the personal care implement (e.g., the shaving razor type is typically associated with three cutting razors defined by metallic pixels patterns in a straight orientation), which can be used to determine and/or predict the degradation and/or the time state of the personal care implement. In some aspects, such shape, pattern, or edge may be used by a segmentation model to determine or detect an area that contains the edge of the cutting razor (e.g., the cutting edge of the shaving razor). For example, image preprocessing can be implemented where the images are analyzed by a segmentation model to isolate or otherwise detect the pixels in the cutting razor area from the razor head. In the example of FIG. 2D, pixel 208t1s1p2 comprises a pixel in a pattern of a cutting razor of the personal care implement, where the edge of the cutting razor defines the sharpness of the razor. The pixel, and the other pixels of the edge or pattern, define a straight, smooth, or otherwise regular cutting edge of the shaving razor indicating that the cutting razor is sharp or otherwise non-degraded. In this way such pixels, including pixel 208t1s1p2, indicate physical degradation (or lack thereof) of the personal care implement of FIG. 2D, which can be used to predict that the personal care implement is in a newer stage time state (e.g., little or no usage).

As a further example, pixel 208t1s1p3, which is located on a top portion of the shaving razor, may comprise a darker pixel (e.g., with lower values in the RGB based channels) in a rectangular shape with surrounding pixels, which may be indicative of a strip of the shaving razor used for hydration, exfoliation, or other purposes as the razor moves across a user's skin. In the example of FIG. 2D, the strip may be shapely formed (in a rectangular shape), uniform in colored, or otherwise well-formed indicating little or no physical degradation of the personal care implement of FIG. 2D, which can be used to predict that the personal care is in a newer stage time state (e.g., little or no usage).

In this way, each of pixel 208t1s1p1, 208t1s1p2, and 208t1s1p3 defines features that comprise pixel data that may be used to train personal care implement AI model (e.g., train a personal care implement AI model, such as described herein for oral care implement AI model 108), to output respective degradation values corresponding to the one or more personal care implements and their respective varied physical degradations at the different time states across the one or more expected personal care implement lifecycles.

In addition to pixels 208t1s1p1, 208t1s1p2, and 208t1s1p3, pixel data 208t1s1p includes various other pixels including remaining portions of the personal care implement (e.g., the shaving razor), including various other pixels that may be analyzed and/or used for training of model(s), and/or analysis by used of already trained models, such as a personal care implement AI model. For example, pixel data 208t1s1p further includes pixels representative of features of further irregular edges, patterns, or otherwise sharp or smooth areas of cutting razors, non-faded colors indicating little or no degradation, no hair stuck between the cutting razors indicating little or no degradation, and/or other features identified in the pixel data and/or at a particular location in the image, where such pixels comprise unique identifiable features, which provides training information for outputting respective degradation values corresponding to the one or more personal care implements and their respective varied physical degradations at the different time states across the one or more expected personal care implement lifecycles, e.g., as described herein.

The image 208t1s1 may also be cropped for comparison or otherwise analysis as described herein. In the example of FIG. 2B, cropped portion 208t1s1c1 represents a first cropped portion of image 208t1s1 that removes portions of the background or non-product features (outside of cropped portion 208t1s1c1) that may not include readily identifiable regions that have a care implement and/or care implement features. As a further example, cropped portion 208t1s1c2 represents a second cropped portion of image 208t1s1 that removes further portions of the image (outside of cropped portion 208t1s1c2) that includes additional background or non-product features compared to the cropped portion 208t1s1c1, and therefore reduces the amount of pixels and data that the give system (e.g., system 100) must store or otherwise analyze as training data.

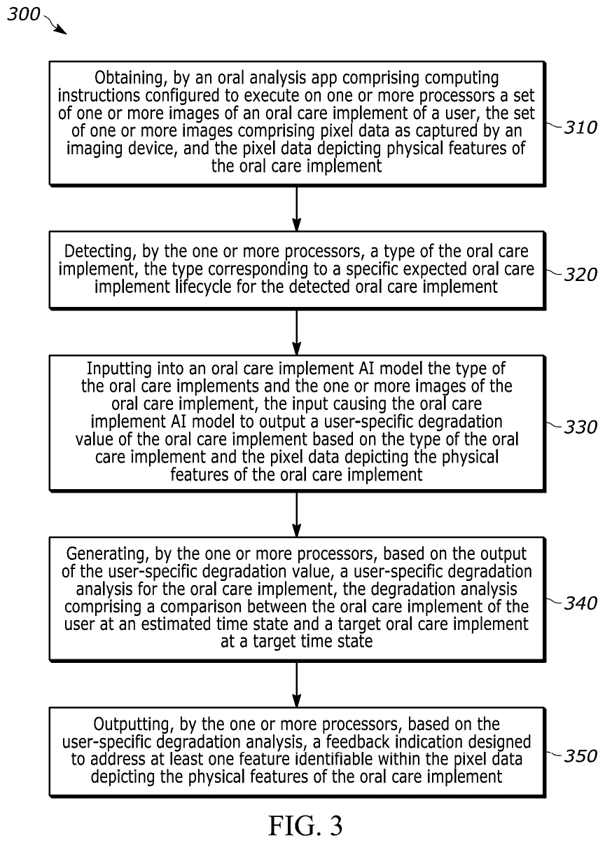

FIG. 3 illustrates an example digital imaging and AI-based method 300 for analyzing oral care implement degradation, in accordance with various embodiments disclosed herein. At block 310, method 300 comprises obtaining, by an oral analysis app, a set of one or more images of an oral care implement of a user (202t1u1). The oral analysis app (e.g., oral analysis app 107 and/or oral analysis app 107a) may comprise computing instructions configured to execute on one or more processors (e.g., of server 102 and/or user computing device 111c1). The set of one or more images can comprise pixel data (202t1u1p) as captured by an imaging device (e.g., a camera of user computing device 111c1). The pixel data may depict physical features (e.g., 202t1u1p1, 202t1u1p2, and 202t1u1p3) of the oral care implement.

At block 320, method 300 comprises detecting, by the one or more processors (e.g., a processor of server 102 and/or of user computing device 111c1), a type (e.g., type 202t1) of the oral care implement. In various aspects, an oral care implement may comprise a manual toothbrush, a battery powered toothbrush, an electrical rechargeable toothbrush, a brush head, a toothbrush refill or cartridge, a tongue scraper, a tongue cleaner, and/or an applicator wand. Detection of the type may also include detection of a brand (e.g., the COLGATE brand or ORAL-B brand). As a further example, detection of the type may also comprise detection of a variety or model of the brush or brush head (e.g., a cross action, 3D whitening, and/or other such variant or model of types of brushes or brush heads). It is to be understood, however, that additional and/or different oral care implements and/or types may be detected and are contemplated herein.

Further, the type may correspond to a specific expected oral care implement lifecycle (e.g., 3 months) for the detected oral care implement. The type may also correspond to allow lookup of a related model number or other identifier of the oral care implement. Additionally, or alternatively, the type of the oral care implement of the user may be identified based on an identifier detected in the pixel data of the set of one or more images. In such aspects, the identifier can be submitted as an input to look up or link to additional data defining the oral care implement in order to identify the oral care implement. The additional data can comprise, at least in some aspects, at least one attribute of the oral care implement. Such aspects may comprise default or factory brush stiffness or softness.

At block 330, method 300 comprises inputting into an oral care implement artificial intelligence (AI) model (e.g., 108 and/or 108a) the one or more images of the oral care implement. In some aspects, the type of the oral care implement may also be input into the oral care implement AI model. The input can cause the oral care implement AI model to output a user-specific degradation value of the oral care implement based on the type of the oral care implement and the pixel data depicting the physical features of the oral care implement. In some aspects, the type of the oral care implement may be detected or otherwise determined by the oral care implement AI model based on the one or more images of the oral care implement alone. However, in other aspects, the type of the oral care implement may be detected or otherwise determined based on the one or more images of the oral care implement in addition to the type as input as text or other value as provided to the oral care implement AI model.

In various aspects, the user-specific degradation value as output by the oral care implement AI model can be based one or more features identifiable within the pixel data of a plurality of training images use to train an oral care implement artificial intelligence model (e.g., oral care implement AI model 108 and/or 108a). The one or more features can comprise, but are not limited to: one or more bristles of the oral care implement of the user, a color or a color degradation of the oral care implement, a shape, an outline, or a deformation of a head of the oral care implement, the type of the oral care implement, and/or the specific expected oral care implement lifecycle for the detected oral care implement.

With respect to the oral care implement AI model, the oral care implement artificial intelligence (AI) model (108), is accessible by the oral analysis app, and trained with degradation data of one or more oral care implements. The oral care implement AI model further trained with pixel data of a plurality of training image sets (e.g., 202t1, 202t2, 202t3) depicting the one or more oral care implements comprising one or more types and having varied physical degradations at different time states (e.g., 202t1s1, 202t1s2, 202t2s1, 202t2s2, 202t3s1, 202t3s2) across one or more expected oral care implement lifecycles. In various aspects, the different time states can define a condition of a given oral care implement including, but not limited to a new state, a before use state, a present state, a during use state, a last-time-of-use-state, a pre-worn state, or a future predicted state. That is, a time state can be new, before use, during use, and/or last/latest time of use. It can also relate to a stage in time such as new/unworn (e.g., an early state), in the exact time as when the image is captured (e.g., a present state) or in a forecasted time (e.g., a future or predicted state).

Still further, each image of the plurality of training images can comprise multiple angles or perspectives depicting the one or more oral care implements. In such aspects, each image of the plurality of training images can comprise multiple angles or perspectives depicting the one or more oral care implements. Additionally, or alternately, each image of the plurality of training images or the set of one or more images of the oral care implement of the user can comprise at least one cropped image removing at least a portion of personally identifiable information (PII) of a user, e.g., as described for FIGS. 2A, 2B, 2C, and/or 2D herein.

In various aspects, the oral care implement AI model is trained with the training images to output respective degradation values corresponding to the one or more oral care implements and their respective varied physical degradations at the different time states across the one or more expected oral care implement lifecycles. The varied physical degradations at the different time states can comprise one or more varied physical characteristics of an oral care implement comprising, including, but not limited to, a visual appearance, a color, a volume, an amount, a dimension, a pattern, a shape of application, a texture, a density, a relative ratio, an efficiency of use, an efficiency of clean, an efficiency of performance and/or a position.

In some aspects, the oral care implement AI model (108) can be further trained with oral behavior data defining usage data of the one or more oral care implements when used by a plurality of corresponding users. In such aspects, the computing instructions of the oral analysis app, when executed by the one or more processors, can further cause the one or more processors to receive user-specific oral behavior data from the user. For example, the oral behavior data may comprise user supplied data provided by the user. In another example, oral behavior data may comprise electronic data as captured by the oral care implement of the user. More generally, human behavior data can be self-reported data as in a questionnaire or an input form that pertains to the context, location, technique, process, and/or perception of the brushing activities. Such data may also comprise human biometric or behavioral brushing, environment, or context data captured via a tracking device such as a brushing application, or sensor, or other biometric device.

The computing instruction may further cause the or more processors (e.g., of server 102 and/or of a computing device 111c1) to input into the oral care implement AI model the user-specific oral behavior data. The oral care implement AI model can then output the user-specific degradation value of the oral care implement further based on the user-specific oral behavior data. In some aspects, the feedback indication may comprise output designed to address at a user-specific activity determined from the user-specific oral behavior data and correlated to the at least one feature identifiable within the pixel data depicting the physical features of the oral care implement.

More generally, in various aspects, an artificial intelligence model, as described herein (e.g. an oral care implement AI model and/or a personal care implement AI model), may be trained using a supervised or unsupervised machine learning program or algorithm. The machine learning program or algorithm may employ a neural network, which may comprise a convolutional neural network, a vision transformer, a deep learning neural network, a large language model (LLM), or a combined learning algorithm or program that learns based on features or feature datasets (e.g., pixel data) in a particular areas of the image of interest. The machine learning programs or algorithms may also include natural language processing, semantic analysis, automatic reasoning, regression analysis, support vector machine (SVM) analysis, decision tree analysis, random forest analysis, K-Nearest neighbor analysis, naïve Bayes analysis, clustering, reinforcement learning, and/or other machine learning algorithms and/or techniques. In some embodiments, the artificial intelligence and/or machine learning based algorithms may be included as a library or package executed on imaging server 102. For example, libraries may include the TENSORFLOW based library, the PYTORCH library, and/or the SCIKIT-LEARN Python library.

Machine learning may involve identifying and recognizing patterns in existing data (such as identifying features of a given oral or personal care implement in the pixel data of image as described herein) in order to facilitate making predictions, classifications, or identification for subsequent data (such as using the AI model on new pixel data of a new image in order to detect, predict, or otherwise output a user-specific degradation value of the oral care implement based on the type of the oral care implement and the pixel data depicting the physical features of the oral care implement).

AI model(s), such as described herein (e.g. an oral care implement AI model and/or a personal care implement AI model), may be created and trained based upon example data (e.g., training data and related pixel data) inputs or data (which may be termed “features” and “labels”) in order to make valid and reliable predictions for new inputs, such as testing level or production level data or inputs. In supervised machine learning, a machine learning program operating on a server, computing device, or otherwise processor(s), may be provided with example inputs (e.g., “features”) and their associated, or observed, outputs (e.g., “labels”) in order for the machine learning program or algorithm to determine or discover rules, relationships, patterns, or otherwise machine learning “models” that map such inputs (e.g., “features”) to the outputs (e.g., labels), for example, by determining, assigning, and/or mapping weights or other metrics to the model across its various feature categories. Such rules, relationships, or otherwise models may then be provided subsequent inputs in order for the model, executing on the server, computing device, or otherwise processor(s), to predict, based on the discovered rules, relationships, or model, an expected output.

In unsupervised machine learning, the server, computing device, or otherwise processor(s), may be required to find its own structure in unlabeled example inputs, where, for example multiple training iterations are executed by the server, computing device, or otherwise processor(s) to train multiple generations of models until a satisfactory model, e.g., a model that provides sufficient prediction accuracy when given test level or production level data or inputs, is generated.

Supervised learning and/or unsupervised machine learning may also comprise retraining, relearning, or otherwise updating models with new, or different, information, which may include information received, ingested, generated, or otherwise used over time. The disclosures herein may use one or both of such supervised or unsupervised machine learning techniques.

The use of AI models can be applied to address degradation of various implements (e.g., toothbrush and/or grooming devices). For example, as described for various aspects, an artificial intelligence (AI) model (e.g., an oral care implement model 108 and/or oral care implement model 108) or otherwise a personal care implement AI model, is accessible by an analysis app, and trained with degradation data of one or more oral care implements and/or one personal care implements as the case may be. An AI model can be trained with pixel data of a plurality of training images depicting the one or more oral care implements comprising one or more types and having varied physical degradations at different time states (e.g., 202t1s1, 202t1s2, 202t2s1, 202t2s2, 202t3s1, 202t3s2, 208t1u1) across one or more expected oral care implement lifecycles.

In one example, an AI model can be trained to analyze user-acquired or otherwise provided images and map brush wear patterns to wear levels. Multiple model variants may be implemented, which may include one or more training a given AI model (e.g., an oral care implement model and/or a personal care implement model) with finetuning, supervised learning, semi-supervised learning, unsupervised learning, and/or a combination thereof. Images of brush heads and the associated wear levels (e.g., as shown and described herein for FIGS. 1, 2A and 2B) may be used to train a given AI model. Wear level scores can be calculated from empirical heuristics based on, by way of non-limiting example, duration of wear the brush has been subjected to, and the perceptible visual degradation rated by a grader or as determined by an initial or first AI model to extract degradation features from the images.

In one example, fine-tuned pre-trained models can be implemented. In such examples, EfficientNet and/or Swin Transformer can be used where pre-trained EfficientNet and Swin Transformer models can be trained with images and fine-tunned to provide high accuracy and computational efficiency. With respect to an oral care implement model, by using segmented brush head images and their associated wear levels (e.g., wear level values 1-5), an oral care implement model based on EfficientNet and Swin Transformer can leverage transfer learning. This approach reduces training time while utilizing the learned features from the original datasets on which these models were pre-trained, such as ImageNet. Fine-tuning allows these architectures to specialize in identifying wear patterns and subtle features specific to brush heads. For example, in such aspects, the oral care implement could then output a user-specific degradation value (e.g., based on the wear level score) of the oral care implement based on the type of the oral care implement and the pixel data depicting the physical features of the oral care implement.

In another example, an oral care implement model may be based on a multi-model approach. In such aspects, an initial contrastive learning model can be trained with unsupervised feature extraction using unlabeled images of brush heads. For example, models or algorithms such as SimCLR or MoCo can be used to extract the features. Features may comprise extracted embedding from the initial contrastive learning model and an associate wear level score (e.g., were level values 1-5). For example, features may comprise images (with pixel data) of user-submitted brush head images that get transformed to respective images embedding data from the feature extraction model, where the image embedding is passed to a secondary wear level classification model. By maximizing the similarity between augmented views of the same image and minimizing the similarity between different images, the initial model learns robust image embeddings that capture essential characteristics of brush heads. In a second phase, after extracting features with the contrastive learning model, the secondary wear classification model (e.g., the oral care implement model) can be trained using supervised learning. In such aspects, the oral care implement model can use the embeddings and their corresponding wear levels to classify brush head wear, enabling a layered architecture that combines unsupervised pretraining with supervised learning refinement. For example, in such aspects, the oral care implement could then output a user-specific degradation value (e.g., based on the wear level score) of the oral care implement based on the type of the oral care implement and the pixel data depicting the physical features of the oral care implement.

In another example, oral care implement model may be implemented using generative AI, such as an LLM based generative AI model. In one aspect, an LLM model may comprise a generative multimodal LLM model that can combines a visual and contextual implementation. More generally, examples of multimodal large language models include, by way of non-limiting example, GPT-4 (e.g., GPT-4o) by OPENAI, GEMINI by GOOGLE, DALL-E, IMAGEBIND (from META), LLaVA, and UNIFIED-IO 2; each of which can process and generate information across various modalities like text, images, audio, and sometimes even video, allowing them to understand and respond to complex prompts combining different data types. In aspects where a care implement model (e.g., an oral care implement AI model) comprises a generative AI model, such generative AI model can be trained with degradation data of one or more oral care implements via fine tuning, retrieval augmented generation (RAG), and/or other generative AI training techniques to configure or otherwise update the care implement AI model (e.g., an oral care implement AI model) to recognize degradation data of one or more oral care implements. Such generative AI training techniques can also be used to further train or otherwise update the care implement AI model (e.g., an oral care implement AI model) with pixel data of a plurality of training images depicting the one or more oral care implements comprising one or more types and having varied physical degradations at different time states across one or more expected oral care implement lifecycles. Use of these generative AI training techniques can train or otherwise configure a generative AI-based care implement AI model (e.g., an oral care implement AI model) to output respective degradation values corresponding to the one or more oral care implements and their respective varied physical degradations at the different time states across the one or more expected oral care implement lifecycles.

For example, a generative AI based model can be adapted to detect care implement degradation or wear (e.g., toothbrush or grooming degradation) through RAG, where the generative AI model is updated with labeled toothbrush images, retrieving relevant examples to enhance its contextual understanding of wear patterns. This retrieval process can update the generative model to produce more accurate assessments by incorporating domain-specific knowledge dynamically, e.g., by training the generative AI model to recognize specific features showing degradation and time states as described herein. Fine-tuning a care implement model (e.g., an oral care implement model) can involve retraining the model on a curated dataset of images showcasing various stages of toothbrush, grooming, or otherwise care wear, along with associated labels or descriptions. By optimizing weights specific to this task, the model improves its ability to analyze input images and generate accurate predictions with respect to varied physical degradations at different time states across one or more expected care implement lifecycles.

In one example, a generative AI-based care implement AI model (e.g., a generative AI-based oral care implement AI model) may comprise an instance of a multimodal LLM model that has been trained via RAG and/or fine-tuning. In such examples, a generative AI model (e.g., such as the GEMINI multimodal LLM model or another LLM model) could be leveraged to synthesize data, improve generalization, or provide explainable insights into the wear level predictions. It may also be used to augment datasets by generating realistic synthetic images of brush heads with varied wear levels, thereby addressing potential data limitations. In one example, a user-submitted image (e.g., image 202t1u1) may include a known wear level of a known brush head and may be compared to a reference image (e.g., image 202t1s1) of the brush head of a same make. The reference image (e.g., image 202t1s1) may have been submitted as part of a reference training set (e.g., training set 202t1), which included a same make or otherwise type of oral care implement (e.g., a make or otherwise type of toothbrush) having the reference image and several example images (e.g., image 202t1s2) oral care implements with having varied physical degradations at different time states across one or more expected oral care implement lifecycles. The generative AI model (e.g., an LLM model) may be prompted, e.g., with a pre-engineered prompt, to ask the generative AI model to compare the images, e.g., the prompt can be: “which brush head is more worn out? Only answer with one of the following output codes: ‘1’ for the first image; ‘2’ for the second image; or ‘0’ if they are of similar wear level.” The generative AI model would then respond with the code, which can then be used as output of a user-specific degradation value (e.g., based on the generative AI output code) of the oral care implement based on the type of the oral care implement and the pixel data depicting the physical features of the oral care implement. As a further example, an additional and/or different prompt may be provided as input to the generative AI model to compare the images (e.g., user provided image 202t1u1, reference image 202t1s1, and example degraded image 202t1s2), where the prompt instructs the generative AI model to, e.g., “take the user provided image and any text the issuer provides (if applicable) together with the following context: {example of all types of brush refills both new and at different used states} TASK is to match the refill type and match to the level of wear.” The generative AI model may then output a feedback indication designed to address at least one feature identifiable within the pixel data depicting the physical features of the oral care implement. This may include a wear level and/or refill type (e.g., a new toothbrush for the user to purchase), for example, as described herein for FIGS. 5A and/or 5B, or elsewhere herein.

In another example, a generative AI-based care implement AI model (e.g., a generative AI-based grooming care implement AI model) may comprise an instance of a multimodal LLM model that has been trained via RAG and/or fine-tuning. In such examples, a generative AI model (e.g., such as the GEMINI multimodal LLM model or another LLM model) could be leveraged to synthesize data, improve generalization, or provide explainable insights into the wear level predictions. It may also be used to augment datasets by generating realistic synthetic images of razor heads with varied wear levels, thereby addressing potential data limitations. In one example, a user-submitted image (e.g., image 208t1u1) may include a known wear level of a known razor head and may be compared to a reference image (e.g., image 208t1s1) of the razor head of a same make. The reference image (e.g., image 208t1s1) may have been submitted as part of a reference training set (e.g., a training set of razor images comprising image 208t1s1), which included a same make or otherwise type of razor care implement (e.g., a make or otherwise type of razor) having the reference image and several example images (e.g., image 208t1s2) grooming care implements with having varied physical degradations at different time states across one or more expected grooming care implement lifecycles. The generative AI model (e.g., an LLM model) may be prompted, e.g., with a pre-engineered prompt, to ask the generative AI model to compare the images, e.g., the prompt can be: “which razor is more worn out? Only answer with one of the following output codes: ‘1’ for the first image; ‘2’ for the second image; or ‘0’ if they are of similar wear level.” The generative AI model would then respond with the code, which can then be used as output of a user-specific degradation value (e.g., based on the generative AI output code) of the razor care implement based on the type of the razor care implement and the pixel data depicting the physical features of the razor care implement. As a further example, an additional and/or different prompt may be provided as input to the generative AI model to compare the images (e.g., user provided image 208t1u1 and reference image 208t1s1), where the prompt instructs the generative AI model to, e.g., “take the user provide image and any text the issuer provides (if applicable) together with the following context: {example of all types of razor refills both new and at different used states}—TASK is to match the refill type and match to the level of wear.” The generative AI model may then output a feedback indication designed to address at least one feature identifiable within the pixel data depicting the physical features of the grooming care implement. This may include a wear level and/or refill type (e.g., a new razor for the user to purchase), for example, as described herein for FIGS. 5A and/or 5B, or elsewhere herein.

With further reference to FIG. 3, at block 340, method 300 comprises generating, by the one or more processors, based on the output of the user-specific degradation value, a user-specific degradation analysis (see, e.g., FIG. 5) for the oral care implement, for example, as shown for FIGS. 5A and 5B herein. The degradation analysis may comprise a comparison between the oral care implement of the user at an estimated time state (e.g., oral care implement time state 202t1s2 showing a worn toothbrush) and a target oral care implement at a target time state (e.g., oral care implement time state 202t1s1 showing a new toothbrush).

In various aspects a target time state can be a new state defining when a given oral care implement is new, e.g., a manufactured by the manufacturer. Additionally, or alternatively, a target time state comprises a time-based state. The time-based state can define, by way of non-limiting example, a state of a given oral care implement as given point in time (e.g., no use, 2 weeks after use, 2 months after use, or the like).

In other aspects, a target time state can comprise a predicted state. A predicted state can be future state or otherwise a future expected state, such as a state defined based on an output for the oral care implement AI model of a degradation value expected for a given oral care implement based on the oral care implement's current state.

In various aspects, a target time state can be based on the comparison between the oral care implement of the user at the estimated time state (e.g., oral care implement time state 202t1s2 showing a worn toothbrush) and a target oral care implement at a target time state. In one example, one or more processors of server 102 and/or user computer device 111c1 may implement a comparison between a user's brush image (e.g., and pixels in the image) with a reference or target image (and related pixels). The reference or target image may comprise an image of an unworn brush of the same make or model as the user's toothbrush having known characteristics including bristle pattern, edges, angles, composition, and more. The comparison to the reference or target image can involve analyzing (e.g., analyzing pixel data) to detect a change in the color distribution of the toothbrush bristles, a change in the shape outline of the bristles, or other changes of features (e.g., pixels) as described herein. The changes may be measured or otherwise defined by a change score (e.g., a numeric value or decimal between 0 and 1) that is mapped to a wear level scale of 1-5, or 1-10, or 1-15, or more levels based on empirical data.

In another example, one or more processors of server 102 and/or user computer device 111c1 may implement a comparison based on the identified make and/or model of an oral care implement (e.g., toothbrush) by selecting one of several artificial intelligence models (e.g., deep learning models) to output a score of the user's image (e.g., on a scale of 1-5, or 1-10, or 1-15 or more levels) based on one or more areas of bristle wear and/or discoloration. In such aspect, each artificial intelligence model can be trained on images for scoring brushes based on any one or more of: a specific type of brush head or refill replacement head shape (e.g., round, oval, rectangular, etc.), or a specific brush variant including its particular characteristics of that variant.

In a still further example, one or more processors of server 102 and/or user computer device 111c1 may implement a comparison based on a user's brush image with a reference or target image, where the reference or target image is an image of brush with a known wear level and characteristics of the same make as the user's brush at a specific time interval of use and/or otherwise wear. For example, in one aspect the comparison may be implement by querying a generative AI model, such as a large language model (LLM) to grade the user's brush image on an ordinal scale (e.g., one of “more”, “less”, or “similar”) to a wear level as that of the reference or target image.

At block 350, method 300 comprises outputting, by the one or more processors, based on the user-specific degradation analysis, a feedback indication (see, e.g., FIG. 5) designed to address at least one feature identifiable within the pixel data depicting the physical features of the oral care implement. In some aspects, the feedback indication may comprise output specific to the user. Such feedback indication may comprise a brushing behavior of the user or a location of the oral care implement when used by the user. Still further the feedback indication may comprise maneuverability of the oral care implement when used by the user (e.g., how the user moves the toothbrush in his or her mouth), the timing of the user when using the oral care implement (e.g., how long the user uses the toothbrush in particular areas of the mouth), and/or impact of the user's brushing behavior on the oral care implement (e.g., how hard the user presses when brushing).

Still further the feedback indication my comprise output comprising number value or range to indicate wear level. For example, such output may comprise a number between 1-5 corresponding to a predicted or classified wear level. Additionally, or alternatively, such output may comprise generation of a number between 0-2 (e.g., as described herein for output regarding a generative AI model), each corresponding to which of the reference or comparison images are more worn. In such aspects, the output data, e.g., comprising a number value or range, can be mapped or otherwise provided as the feedback indication, which may include text regarding the predicted wear level, e.g., a wear level that indicates to a user in terms of change recommendation and associated oral health treatment or otherwise outcomes.

Still further, in some aspects, a feedback indication may comprise a qualitative rating (e.g., such as s score as describe herein); a numeric assessment (e.g., a percentage or wear level as described herein); a visual projection (e.g., such as a user interface on a display screen); text (e.g., on a display screen); a categorical rating (e.g., a classification such as “worn” or “new); an augmented reality (AR) or virtual relating (VR) projection (e.g., showing an overlay of a new oral care implement on top of a worn or otherwise old oral care implement); and/or (g) a video (e.g., showing proper use of an oral care implement to reduce degradation overtime).

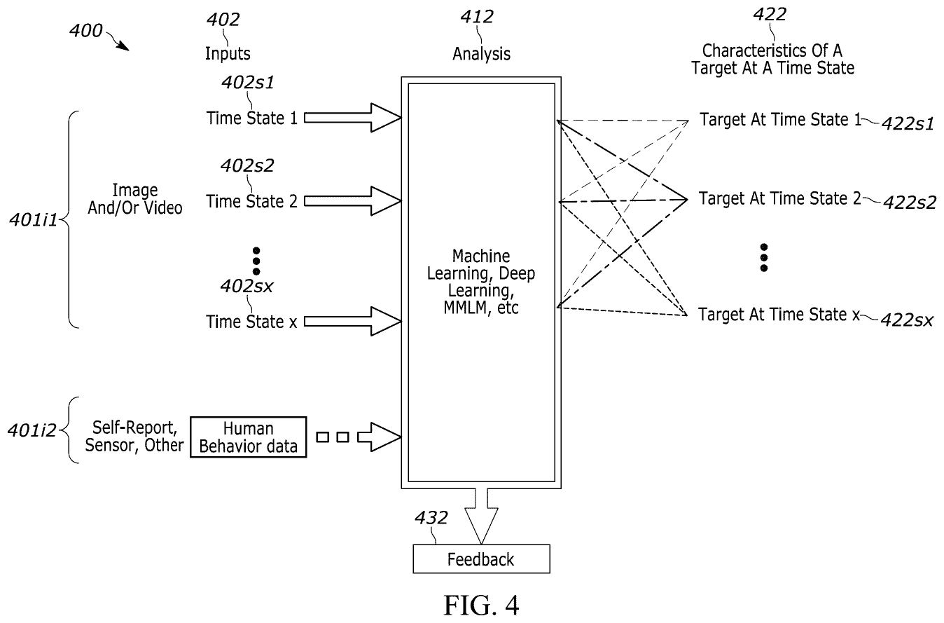

FIG. 4 illustrates an example digital imaging and AI-based method 400 for analyzing oral care implement degradation including analyzing varied physical degradations at different time states (e.g., 402s1, 402s2, 402sx, 422s1, 422s2, 422sx; 202t1s1, 202t1s2, 202t2s1, 202t2s2, 202t3s1, 202t3s2) across one or more expected oral care implement lifecycles, in accordance with various embodiments disclosed herein. Method 400 may be implemented in the same manner as described herein for method 300, where method 400 further illustrates implementation and/or analysis of oral care implement degradation detection including analyzing varied physical degradations at different time states (e.g., first time state 402s1, second time state 402s2, and further time state(s) 402sx). The implementation of FIG. 4 illustrates a further method that may be used to train a care implement AI model, e.g., such as an oral care implement AI model (e.g., oral care implement AI model 108) or otherwise a personal care implement AI model. Generally, any of these given time states can represent a new time state, before use time state, during use time state, and/or last/latest time state, each defining a state of time at which a given care implement (e.g., an oral care implement or a grooming care implement) is new, used, applied, or otherwise imaged by a user. For example, a user can provide new, updated, or further images of the care implement at various times use or otherwise imaging (e.g., via picture capture) a care implement, where adjustments to use or imaging of the care implement can be made by the user over time. For example, the user can reassess care implement usage over various states of time until a desired wear level (or lack thereof) is achieved.

As shown for FIG. 4, computing instructions of an app (e.g., an oral analysis app and/or personal analysis app, such as a grooming analysis app), when executed by one or more processors (e.g., one or more processors of a computing device and/or server 102), may cause the one or more processors to obtain input 402 of a set of one or more images 401i1 of a given care implement (e.g., an oral care implement and/or a product care implement). For example, input 402 of a set of one or more images may comprise a first set of images at first time state 402s1, a second set of images at second time state 402s2, and/or a further set of images at time state 402sx. It is to be understood that the further set of images may represent a third set of images at a third time state, a fourth set of images at a fourth time state, and so on.

The set of images 401i1 as input 402 at the various time states may comprise pixel data (e.g., first pixel data at first time state 402s1, second pixel data at second time state 402s2, and further pixel data at further time state 402sx) as captured by the imaging device (e.g., a camera of computing device 111c1). Such pixel data (e.g., first, second, and/or further pixel data) may depict a care implement at the given time state (e.g., first, second, and/or further time state 402s1, 402s2, and/or 402sx, respectively).

In addition, the input 402 may comprise human behavior data 401i2, which may comprise user-report, sensor, or other data regarding the user's user of the care implement, for example, as described herein. For example, such human behavior data 401i2 may comprise data input from a questionnaire or otherwise input form as displayed on a user inference (e.g., as describe herein for FIG. 5A) that pertains to the context, location, technique, process, and/or perception of the brushing activities. Such data may also comprise human biometric or behavioral brushing, environment, or context data captured via a tracking device such as a brushing application, or sensor, or other biometric device.

The input 402 of the set of images at the various time states may be provided to an artificial intelligence model 412, such as oral care implement AI model 108 and/or oral care implement AI model 108a, or more generally a personal care implement AI model, which may implement deep learning, a multi-model language model (MMLM) model, or the like e.g., a model trained with various weights on the features identifiable with the set of images. The artificial intelligence model 412 may generate output 422 regarding a given time state defining characteristics of a target at a timestamp, which may be used for comparison to the user's image at the given time state. For example, at the first time state 402s1, the artificial intelligence model 412 may analyze (at 422s2) the images of a care implement of a user to generate output of a first analysis comprising a comparison of a first image of a care implement as depicted in first pixel data (e.g., as shown for FIGS. 2A and/or 2C herein) at first time state 402s1 to a second image of a second care implement of the care implement at a second time state 422s1 (e.g., as shown for FIGS. 2B and/or 2D herein, respectively). At 422s1, the second care implement of the care implement may define a used or worn care implement at the second time state 422s2 and can use to train artificial intelligence model 412 based on a difference between an expected wear state at a given time (based on output 422) and the user's actual wear state of the given care implement (based on the input 402). It is to be understood that other output (e.g., 422s1 and/or 422sx) may define other similar comparisons to other initial time states (e.g., at 402s2 and/or 402sx, respectively), where each time state comparison may show additional and/or different wear as the care implement is used, and which further trains and updates the accuracy of artificial intelligence model 412.

Once trained, artificial intelligence model 412 can output feedback indications 432 that comprise output for each of the various time states. For example, for the first time state 422s2, a feedback indication may be output based on a new image provided by a user designed to address at least one feature identifiable within the pixel data depicting the physical features of the oral care implement.

FIG. 5A illustrates an example user interface 502 as rendered on a display screen 500 of a user computing device in accordance with various embodiments disclosed herein. For example, as shown in the example of FIG. 5, user interface 502 may be implemented or rendered via an application (app) executing on user computing device 111c1. User interface 502 may be implemented or rendered via a native app executing on user computing device 111c1. In the example of FIG. 5A, user computing device 111c1 is a user computer device as described for FIG. 1, e.g., where 111c1 is illustrated as an APPLE iPhone that implements the APPLE iOS operating system and that has display screen 500. User computing device 111c1 may execute one or more native applications (apps) on its operating system, including, for example, oral analysis app as described herein. Such native apps may be implemented or coded (e.g., as computing instructions) in a computing language (e.g., SWIFT) executable by the user computing device operating system (e.g., APPLE iOS) by the processor of user computing device 111c1.

Additionally, or alternatively, user interface 502 may be implemented or rendered via a web interface, such as via a web browser application, e.g., Safari and/or Google Chrome app(s), or other such web browser or the like.

As shown in the example of FIG. 5A, user interface 502 comprises a graphical representation (e.g., of image 202t1u1 or portion thereof) of an oral care implement (e.g., a user's toothbrush). Image 202t1u1 may comprise the image of the oral care implement (or graphical representation thereof) comprising pixel data (e.g., pixel data 202t1u1p) of at least a portion (e.g., a cropped portion) of the oral care implement as described herein. In the example of FIG. 5A, graphical representation or image (e.g., image 202t1u1) of the oral care implement is annotated with one or more graphics (e.g., annotation 202t1u1au) regarding the pixel data depicting physical features (e.g., 202t1u1p1, 202t1u1p2, and 202t1u1p3) of the oral care implement. For example, the area of pixel data of the oral care implement may be annotated or overlaid on top of the image (e.g., image 202t1u1) to highlight the area or feature(s) identified within the pixel data (e.g., feature data and/or raw pixel data) by the oral care implement AI model (e.g., oral care implement AI model 108). In various embodiments, the pixels identified as the specific features (e.g., any one of pixels 202t1u1p1-202t1u1p3), may be highlighted or otherwise annotated when rendered on display screen 500.

In various aspects, a feedback indication may be rendered on a display screen (e.g., display screen 500) to indicate (e.g., graphically indicate in the example of FIG. 5A) a difference or similarity, or otherwise degradation between the oral care implement of the user and the target oral care implement. Still further, additionally or alternatively, a reference oral care implement (e.g., reference oral care implement at target time state 202t1s1) may be rendered on a display screen (e.g., display screen 500). The reference oral care implement can illustrate an expected or otherwise manufactured or new appearance or state of the oral care implement, which may comprise depiction of a condition of the bristles of the oral care implement, a color of the oral care implement, a dimension of the oral care implement, a pattern of the oral care implement, a shape of the oral care implement, or the like.

As shown by way of example for FIG. 5A, an annotation 202t1u1a is shown as a superimposed image of a wear level value (e.g., a value of “4”) on top of the user submitted image of the user's oral care implement. In this way, the annotation 202t1u1a graphically and visually illustrates and compares the oral care implement, e.g., at a given time state. The wear level value of “4” indicates that the oral care implement 202t1u1 of the user is very worn (e.g., where the wear level is on a scale from 1-5 as described herein). Such wear level value may be based on the pixel(s) detected for the oral care implement and may be determined based the amount of pixels that include miscolored, splayed, or otherwise irregular bristles or patterns thereof compared to a known reference oral care implement (e.g., reference oral care implement at target time state 202t1s1). It is to be understood that other graphical and/or textual rendering types or values are contemplated herein, where graphical and/or textual rendering types or values may be rendered, for example, such as additional and/or different graphics or text to describe or illustrate the oral care implement comparison between image 202t1u1 of user's oral care implement at a first time state (e.g., three months of use) and, reference oral care implement at target time state 202t1s1 (e.g., a new time state).

User interface 502 may also include or render a feedback indication 510 in the form of a message 510m. In the embodiment of FIG. 5A, the feedback indication 510 comprises a message 510m on display screen 500 designed to indicate that the wear level of the user's toothbrush as detected in image 202t1u1 is at a wear level of 4 (“severe wear detected”). The message further indicates features detected with the pixel data that result in the wear level of 4, e.g., that there has been detected high level of bristle splay and a decent level of color change.

User interface 502 may also include or render a brush wear analysis 512. For example, the oral analysis app may render, on a display screen of a computing device (e.g., computing device 111c1), at least one brushing behavior recommendation based on the feedback indication. In various aspects, the brushing behavior recommendation may comprise a textual recommendation, an imaged based recommendation, and/or virtual rendering of the care implement (e.g., electronic toothbrush), and/or an augemented reality (AR) based recommendation rendered in a proximity to or superimposed on the display screen with the oral care implement (e.g. as shown for 202t1u1a). Further, a brushing behavior recommendation can be displayed on the display screen 500 of the computing device with instructions for adjusting a brushing technique to deter oral care implement degradation identifiable in the pixel depicting the oral care implement of the user. For example, in the embodiment of FIG. 5A, brush wear analysis 512 comprises a message 512m to the user designed to address at least one feature identifiable within the pixel data depicting the physical features of the oral care implement. As shown in the example of FIG. 5A, message 512m recommends to the user to use an electronic toothbrush to increase the consistency of the user's brush pattern.

In various aspects, a brushing behavior recommendation may comprise a product recommendation 522 for a manufactured product 524r. For example, message 512m also includes a product recommendation that may have increased efficacy for the user, e.g., an electronic toothbrush which may reduce the user's impact of wear on his or her oral care implement by increasing the consistency of the user's brush pattern. The product recommendation can be correlated to the identified feature within the pixel data (e.g., as identified by indication 524p) and the user computing device 111c1 and/or server 102 can be instructed to output the product recommendation when the feature (e.g., splayed bristles and/or color change) is identified or classified.

User interface 502 may further include a selectable UI button 524s to allow the user (e.g., the user of the oral care implement of image 202t1u1) to select for purchase or shipment the corresponding product (e.g., manufactured product 524r). In some embodiments, selection of selectable UI button 524s may cause the recommended product(s) to be shipped to the user and/or may notify a third party that the individual is interested in the product(s). For example, either user computing device 111c1 and/or imaging server 102 may initiate, based on the feedback indication 510 and/or the brush wear analysis 512, the manufactured product 524r (e.g., an electronic toothbrush) for shipment to the user. In such aspects, the product can be packaged and shipped to the user.

In some embodiments, a brushing behavior recommendation may be rendered on the display screen 500 in real-time or near-real time, during, or after receiving, the set of images. For example, the brushing behavior recommendation can be displayed on the display screen of the computing device with instructions for treating, with the manufactured product, the at least one feature identifiable in the pixel data comprising the oral care implement of the user. Still further, any one or more of graphical representations (e.g., image 202t1u1), with graphical or textual annotations (e.g., annotation 202t1u1a), or other information shown for FIG. 5A, may be rendered (e.g., rendered locally on display screen 500) in real-time or near-real time during or after receiving, the image of the care implement. In embodiments where the image is analyzed by imaging server 102, the image may be transmitted and analyzed in real-time or near real-time by imaging server 102.

In some embodiments, the user may provide a new image that may be transmitted to imaging server 102 for updating, retraining, or reanalyzing by oral care implement AI model. In other embodiments, a new image that may be locally received on computing device 111c1 and analyzed, by oral care implement AI model, on the computing device 111c1.

In addition, as shown in the example of FIG. 5A, the user may select selectable button 512i for reanalyzing (e.g., either locally at computing device 111c1 or remotely at imaging server 102) a new image at new or otherwise additional time state (e.g., as shown for FIG. 4 herein). Selectable button 512i may cause user interface 502 to prompt the user to attach for analyzing a new image. Imaging server 102 and/or a user computing device such as user computing device 111c1 may receive a new image comprising pixel data of a care implement. The new image can be captured by the imaging device. The new image (e.g., image 202t1u1) may comprise pixel data of an oral care implement, grooming care implement, or other image or feature(s) as described herein. The oral care implement AI model, executing on the memory of the computing device (e.g., imaging server 102), may analyze the new image captured by the imaging device to output respective degradation values corresponding to the one or more oral care implements and their respective varied physical degradations at the different time states across the one or more expected oral care implement lifecycles, or implement other aspects as described herein. For example, the computing device (e.g., imaging server 102) may output, based on a comparison of the image and the new image, a further feedback indication, for example, as described for FIG. 3 or 4 or elsewhere herein.

In various embodiments, a graphical representation or image (e.g., image 202t1u1), with graphical annotations (e.g., area of pixel data 202t1u1p), annotations (e.g., annotation 202t1u1a), the brush wear analysis 512, and/or other data may be transmitted, via the computer network (e.g., from an imaging server 102 and/or one or more processors) to user computing device 111c1, for rendering on display screen 500. In other embodiments, no transmission to the imaging server of the user's specific image occurs, where such information or data may instead be generated locally, by the oral care implement model 108a executing and/or implemented on the user's mobile device (e.g., user computing device 111c1) and rendered, by a processor of the mobile device, on display screen 500 of the mobile device (e.g., user computing device 111c1).

FIG. 5B illustrates a further example user interface 551 as rendered on the display screen 500 of the user computing device 111c1 as described for FIG. 5A and in accordance with various embodiments disclosed herein. In some aspects, user interface 551 may be rendered when a user selects a detailed view button 514 (“View Full Report”) from user interface 502 of FIG. 5A.

In the example of FIG. 5B, user interface 551 indicates in display portion 552 that the level of wear detected is a wear level “4” (as described herein), which indicates a severe wear detected state. Further, user interface 551 indicates in display portion 554 that the level of color discoloration is detected is an ordinal level of “medium.” In some aspects, the “medium” output may determine based on a range of values as output by the oral care implement AI model, where a medium range of values causes “medium” to be output, and where a low range of values causes “low” to be output, and where a high range of values causes “high” to be output.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A digital imaging and artificial intelligence (AI)-based system configured to analyze oral care implement degradation, the digital imaging and AI-based system comprising:
one or more processors;
an oral analysis app comprising computing instructions configured to execute on the one or more processors; and
an oral care implement artificial intelligence (AI) model, accessible by the oral analysis app, and trained with degradation data of one or more oral care implements, the oral care implement AI model further trained with pixel data of a plurality of training images depicting the one or more oral care implements comprising one or more types and having varied physical degradations at different time states across one or more expected oral care implement lifecycles, and the oral care implement AI model trained to output respective degradation values corresponding to the one or more oral care implements and their respective varied physical degradations at the different time states across the one or more expected oral care implement lifecycles,
wherein the computing instructions of the oral analysis app when executed by the one or more processors, cause the one or more processors to:
obtain a set of one or more images of an oral care implement of a user, the set of one or more images comprising pixel data as captured by an imaging device, and the pixel data depicting physical features of the oral care implement,
detect a type of the oral care implement, the type corresponding to a specific expected oral care implement lifecycle for the detected oral care implement,
input into the oral care implement AI model the one or more images of the oral care implement, the input causing the oral care implement AI model to output a user-specific degradation value of the oral care implement based on the type of the oral care implement and the pixel data depicting the physical features of the oral care implement,
generate, based on the output of the user-specific degradation value, a user-specific degradation analysis for the oral care implement, the degradation analysis comprising a comparison between the oral care implement of the user at an estimated time state and a target oral care implement at a target time state,
output, based on the user-specific degradation analysis, a feedback indication designed to address at least one feature identifiable within the pixel data depicting the physical features of the oral care implement.

2. The digital imaging and AI-based system of claim 1, wherein the oral care implement AI model is further trained with oral behavior data defining usage data of the one or more oral care implements when used by a plurality of corresponding users,
wherein the computing instructions of the oral analysis app when executed by the one or more processors, further cause the one or more processors to:
receive user-specific oral behavior data from the user, and
input into the oral care implement AI model the user-specific oral behavior data, wherein the oral care implement AI model outputs the user-specific degradation value of the oral care implement further based on the user-specific oral behavior data,
wherein the feedback indication further comprises output designed to address at a user-specific activity determined from the user-specific oral behavior data and correlated to the at least one feature identifiable within the pixel data depicting the physical features of the oral care implement.

3. The digital imaging and AI-based system of claim 1, wherein the user-specific degradation value as output by the oral care implement AI model is based on a feature identifiable within the pixel data of the plurality of training images, wherein the feature is selected from one or more bristles of the oral care implement of the user, a color, a shape, an outline, a deformation of the oral care implement, an expected oral care implement lifecycle and combinations thereof.

4. The digital imaging and AI-based system of claim 1, wherein the varied physical degradations at the different time states comprise one or more varied physical characteristics of an oral care implement selected from a visual appearance, a color, a volume, an amount, a dimension, a pattern, a shape of application, a texture, a density, a relative ratio, an efficiency of use, an efficiency of clean, an efficiency of performance, a position and combinations thereof.

5. The digital imaging and AI-based system of claim 1, wherein the different time states define a condition of a given oral care implement comprising: a new state, a before use state, a present state, a during use state, a last-time-of-use-state, a pre-worn state, or a future predicted state.

6. The digital imaging and AI-based system of claim 1, wherein the target time state comprises one of: a new state; a time-based state, or a predicted state.

7. The digital imaging and AI-based system of claim 1, wherein the feedback indication comprises at least one of a qualitative rating, a numeric assessment, a visual projection, text, a categorical rating, an augmented reality projection, a virtual reality projection and a video.

8. The digital imaging and AI-based system of claim 1, wherein the type of the oral care implement of the user is identified based on an identifier detected in the pixel data of the set of one or more images, wherein the identifier is submitted as an input to look up or link to additional data defining the oral care implement.

9. The digital imaging and AI-based system of claim 1, wherein each image of the plurality of training images comprises multiple angles or perspectives depicting the one or more oral care implements, and wherein each image of the plurality of training images comprises multiple angles or perspectives depicting the one or more oral care implements.

10. The digital imaging and AI-based system of claim 1, wherein the computing instructions of the oral analysis app when executed by the one or more processors, cause the one or more processors to render on a display screen of a computing device the feedback indication, a brushing behavior recommendation based on the feedback indication or a combination thereof.

11. The digital imaging and AI-based system of claim 10, wherein the brushing behavior recommendation is displayed on the display screen of the computing device with instructions for adjusting a brushing technique to deter oral care implement degradation identifiable in the pixel depicting the oral care implement of the user.

12. The digital imaging and AI-based system of claim 10, wherein the at least one brushing behavior recommendation is rendered on the display screen in real-time or near-real time, during, or after receiving, the set of images.

13. The digital imaging and AI-based system of claim 10, wherein the at least one brushing behavior recommendation is displayed on the display screen of the computing device with instructions for treating, with the manufactured product, the at least one feature identifiable in the pixel data comprising the oral care implement of the user.

14. A digital imaging and artificial intelligence (AI)-based method for analyzing oral care implement degradation, the digital imaging and AI-based method comprising:
obtaining, by an oral analysis app comprising computing instructions configured to execute on one or more processors a set of one or more images of an oral care implement of a user, the set of one or more images comprising pixel data as captured by an imaging device, and the pixel data depicting physical features of the oral care implement;
detecting, by the one or more processors, a type of the oral care implement, the type corresponding to a specific expected oral care implement lifecycle for the detected oral care implement;
inputting into an oral care implement artificial intelligence (AI) model the one or more images of the oral care implement, the input causing the oral care implement AI model to output a user-specific degradation value of the oral care implement based on the type of the oral care implement and the pixel data depicting the physical features of the oral care implement,
wherein the oral care implement AI model is accessible by the oral analysis app, and is trained with degradation data of one or more oral care implements, the oral care implement AI model further trained with pixel data of a plurality of training images depicting the one or more oral care implements comprising one or more types and having varied physical degradations at different time states across one or more expected oral care implement lifecycles, and wherein the oral care implement AI model trained to output respective degradation values corresponding to the one or more oral care implements and their respective varied physical degradations at the different time states across the one or more expected oral care implement lifecycles;
generating, by the one or more processors, based on the output of the user-specific degradation value, a user-specific degradation analysis for the oral care implement, the degradation analysis comprising a comparison between the oral care implement of the user at an estimated time state and a target oral care implement at a target time state; and
outputting, by the one or more processors, based on the user-specific degradation analysis, a feedback indication designed to address at least one feature identifiable within the pixel data depicting the physical features of the oral care implement.

15. The digital imaging and AI-based method of claim 14, wherein the oral care implement AI model is further trained with oral behavior data defining usage data of the one or more oral care implements when used by a plurality of corresponding users, and
wherein the digital imaging and AI-based method further comprises:
receive user-specific oral behavior data from the user, and
input into the oral care implement AI model the user-specific oral behavior data, wherein the oral care implement AI model outputs the user-specific degradation value of the oral care implement further based on the user-specific oral behavior data,
wherein the feedback indication further comprises output designed to address at a user-specific activity determined from the user-specific oral behavior data and correlated to the at least one feature identifiable within the pixel data depicting the physical features of the oral care implement.

16. The digital imaging and AI-based method of claim 14, wherein the different time states define a condition of a given oral care implement comprising: a new state, a before use state, a present state, a during use state, a last-time-of-use-state, a pre-worn state, or a future predicted state.

17. The digital imaging and AI-based method of claim 14, wherein the feedback indication comprises at least one of: (a) a qualitative rating; (b) a numeric assessment; (c) a visual projection; (d) text; and/or (e) a categorical rating.

18. The digital imaging and AI-based method of claim 14, wherein each image of the plurality of training images or the set of one or more images of the oral care implement of the user comprises at least one cropped image removing at least a portion of personally identifiable information (PII) of a user.

19. The digital imaging and AI-based method of claim 14 further comprising rendering, on a display screen of a computing device, the feedback indication to indicate a difference or degradation between the oral care implement of the user and the target oral care implement, a brushing behavior recommendation based on the feedback indication, or a combination thereof.

20. The digital imaging and AI-based method of claim 19, wherein the at least one brushing behavior recommendation is displayed on the display screen of the computing device with instructions for adjusting a brushing technique to deter oral care implement degradation identifiable in the pixel depicting the oral care implement of the user.
